(19) United States
(12) Patent Application Publication
(10) Pub. No.: US 2026/0032492 A1
(43) Pub. Date: Jan. 29, 2026

(54) ENHANCED CROSS-LINK INTERFERENCE AND SELF-INTERFERENCE REPORTING

(71) Applicant: QUALCOMM Incorporated, San Diego, CA (US)

(72) Inventors: Abdelrahman Mohamed Ahmed Mohamed Ibrahim, San Diego, CA (US); Muhammad Sayed Khairy Abdelghaffar, San Jose, CA (US); Ruiming Zheng, Beijing (CN); Seyedkianoush Hosseini, San Diego, CA (US); Ahmed Attia Abotabl, San Diego, CA (US); Huilin Xu, Temecula, CA (US)

(21) Appl. No.: 18/998,951

(22) PCT Filed: Oct. 7, 2022
(86) PCT No.: PCT/CN2022/123725

§ 371 Date: Jan. 27, 2025

(51) Int. Cl. H04W 24/10; H04B 17/318

(52) U.S. Cl. CPC H04W 24/10; H04B 17/328

(57) ABSTRACT

This disclosure provides systems, methods, and devices for wireless communication that support enhanced cross-link interference (CLI) and self-interference (SI) reporting. In a first aspect, an apparatus for wireless communication includes at least one processor; and a memory coupled to the at least one processor. The at least one processor is configured to: generate cross-link interference (CLI) information corresponding to cross-link interference; and transmit CLI report information including one or more CLI reports. Each CLI report corresponds to a respective serving cell of one or more serving cells, and each CLI report includes respective CLI information. Each CLI report of the one or more CLI reports includes a respective report type indication, and each respective report type indication is indicative of whether the CLI information includes actual CLI information or estimated CLI information. Other aspects and features are also claimed and described.

### TECHNICAL FIELD

Aspects of the present disclosure relate generally to wireless communication systems, and more particularly, to enhanced cross-link interference (CLI) and self-interference (SI) reporting. Some features may enable and provide improved communications, including CLI and SI estimation and reporting for multiple cells.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus for wireless communication includes at least one processor; and a memory coupled to the at least one processor. The at least one processor is configured to: generate cross-link interference (CLI) information corresponding to cross-link interference, wherein the cross-link interference corresponds to one or more serving cells; and transmit CLI report information including one or more CLI reports, wherein each CLI report of the one or more CLI reports corresponds to a respective serving cell of the one or more serving cells, wherein each CLI report of the one or more CLI reports includes respective CLI information of the CLI information corresponding to the respective serving cell to which the respective CLI report corresponds, wherein each CLI report of the one or more CLI reports includes a respective report type indication, and wherein each respective report type indication is indicative of whether the respective CLI information included in the respective CLI report to which it corresponds includes respective actual CLI information or respective estimated CLI information.

In another aspect of the disclosure, an apparatus for wireless communication includes at least one processor; and a memory coupled to the at least one processor. The at least one processor is configured to: receive, from a second network node, cross-link interference (CLI) report information including one or more CLI reports, wherein each CLI report of the one or more CLI reports corresponds to a respective serving cell of one or more serving cells, wherein each CLI report of the one or more CLI reports includes respective CLI information of CLI information corresponding to the respective serving cell to which the respective CLI report corresponds, wherein each CLI report of the one or more CLI reports includes a respective report type indication, and wherein each respective report type indication is indicative of whether the respective CLI information included in the respective CLI report to which it corresponds includes respective actual CLI information or respective estimated CLI information; determine, based on the CLI report information, a remediation action configured to reduce CLI for the second network node; and operate based on the remediation action

In another aspect of the disclosure, an apparatus for wireless communication includes a transmitter; a receiver; at least one processor; and a memory coupled to the at least one processor. The at least one processor is configured to: generate self-interference (SI) information corresponding to self-interference, wherein the self-interference corresponds interference caused by the transmitter and received at the receiver; and transmit SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information.

In another aspect of the disclosure, an apparatus for wireless communication includes at least one processor; and a memory coupled to the at least one processor. The at least one processor is configured to: receive, from a second network node, SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information; determine, based on the SI report information, a remediation action configured to reduce SI for the second network node; and operate based on the remediation action.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a diagram of a first example of full-duplex operations.

FIG. 3B is a diagram of a second example of full-duplex operations.

FIG. 3C is a diagram of a third example of full-duplex operations.

FIG. 3D is a diagram of a fourth example of full-duplex operations.

FIG. 3E is a diagram of a fifth example of full-duplex operations.

FIG. 3F is a diagram of a sixth example of full-duplex operations.

FIG. 4 is a block diagram illustrating an example wireless communication system that supports enhanced cross-link interference (CLI) or self-interference (SI) reporting according to one or more aspects.

FIG. 5 is a flow diagram illustrating an example process that supports enhanced channel CLI or SI reporting according to one or more aspects.

FIG. 6 is a block diagram illustrating an example of CLI or SI estimation according to one or more aspects.

FIGS. 7A-10B are block diagrams each illustrating an example CLI or SI reporting formats according to one or more aspects.

FIG. 11A is a block diagram illustrating a subband configuration for CLI or SI estimation according to one or more aspects.

FIGS. 11B and 11C are block diagrams illustrating an example of CLI or SI estimation for subbands according to one or more aspects.

FIGS. 12A-13B are block diagrams each illustrating an example CLI or SI reporting formats according to one or more aspects.

FIG. 14 is a flow diagram illustrating an example process that supports enhanced CLI or SI reporting according to one or more aspects.

FIG. 15 is a flow diagram illustrating an example process that supports enhanced CLI or SI reporting according to one or more aspects.

FIG. 16 is a block diagram of an example UE that supports enhanced CLI or SI reporting according to one or more aspects.

FIG. 17 is a block diagram of an example base station that supports enhanced CLI or SI reporting according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

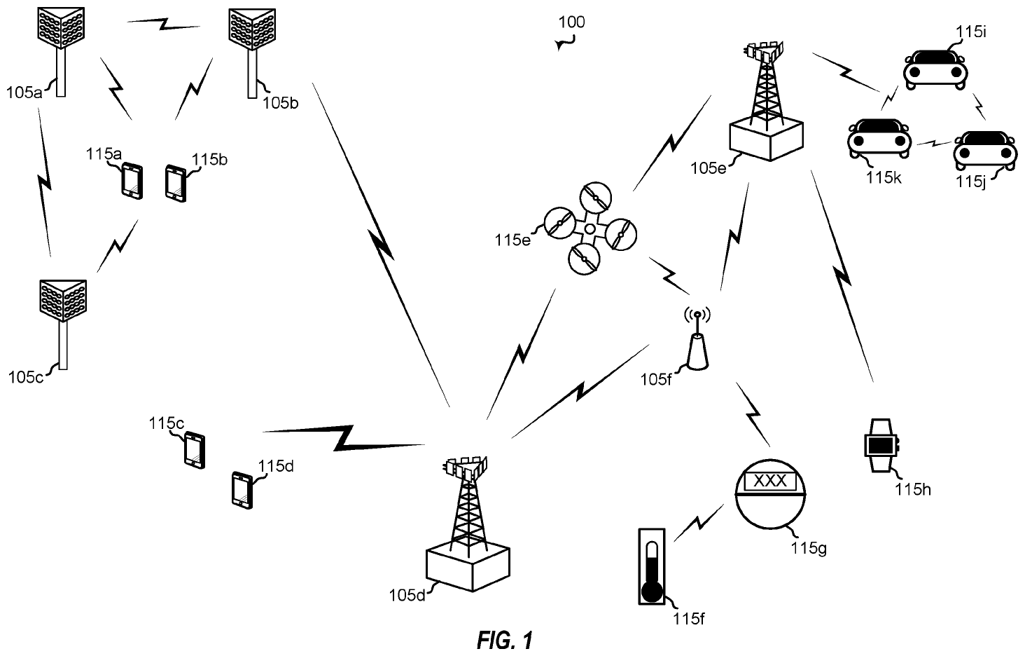

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

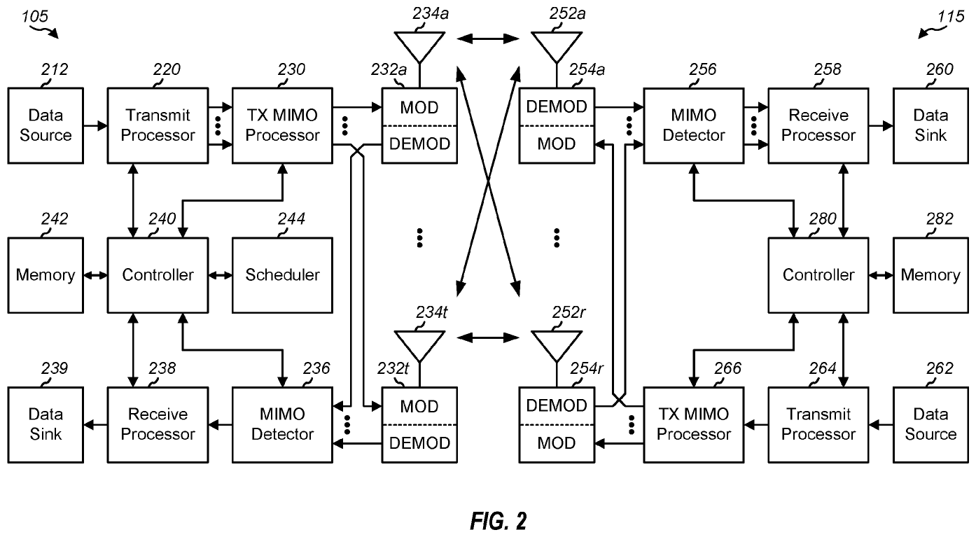

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

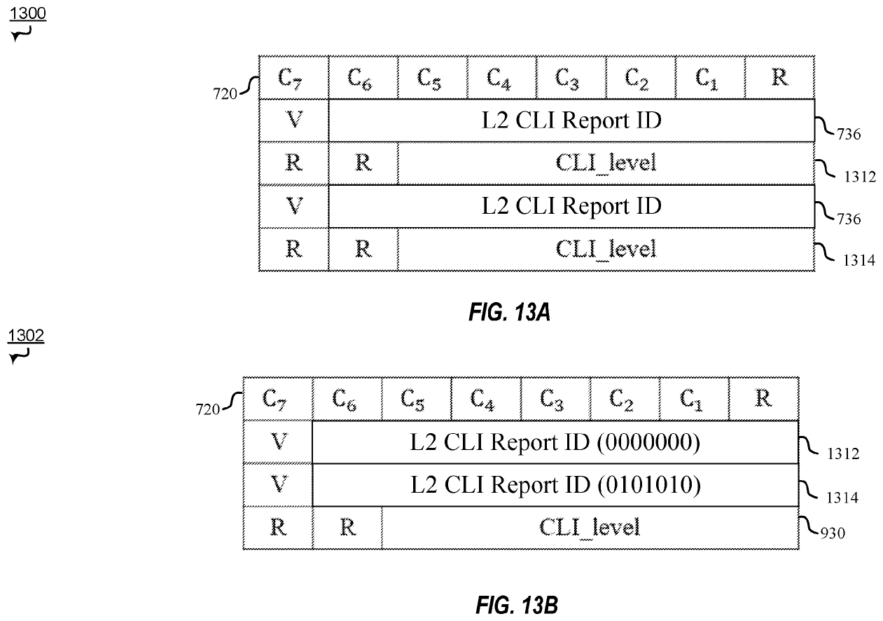

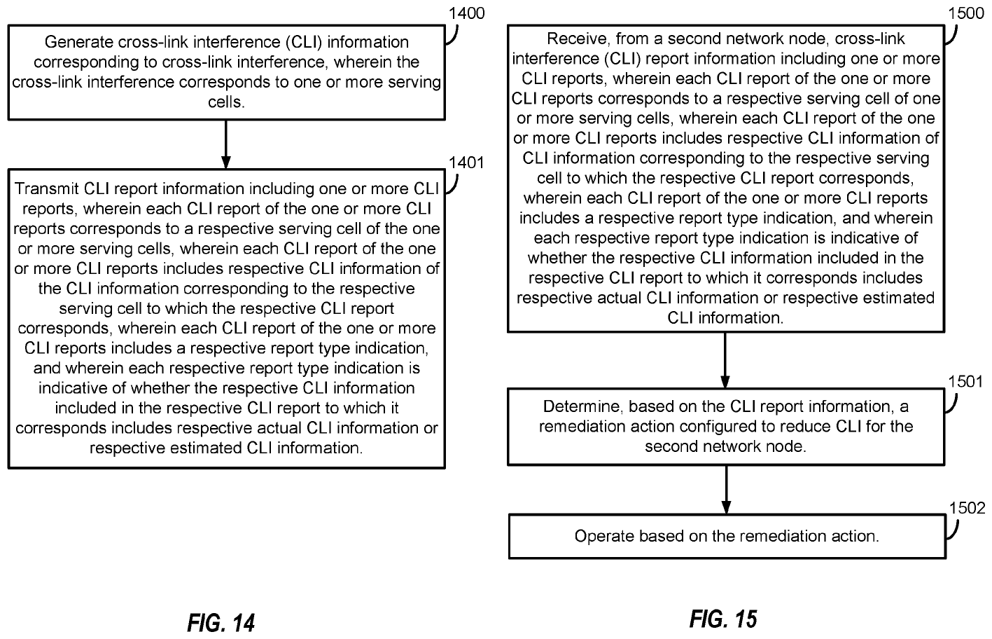

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 14 and 15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

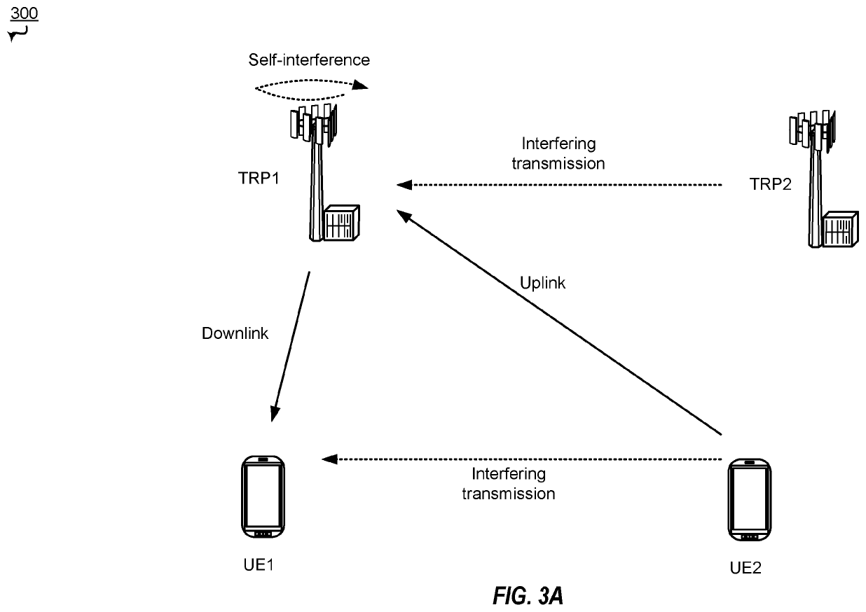

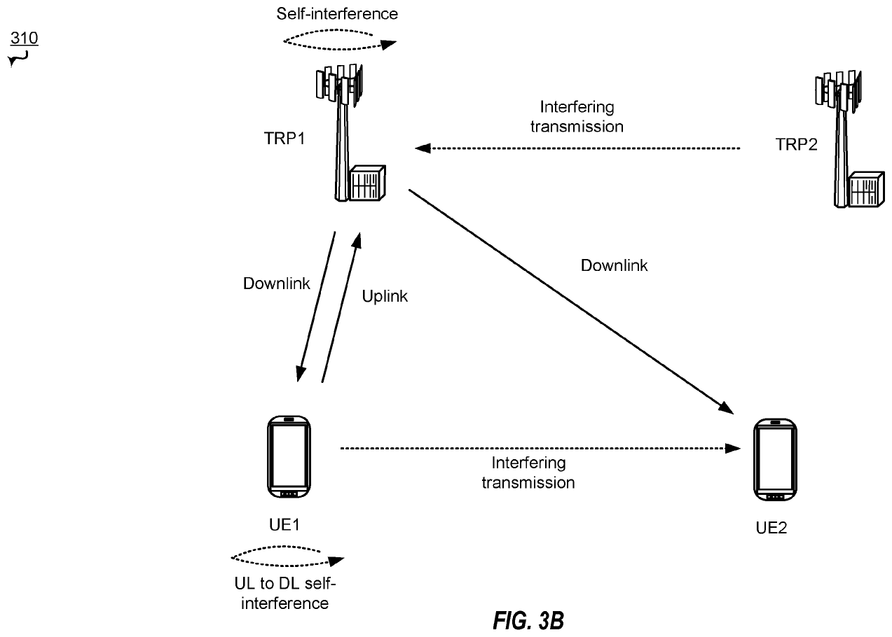

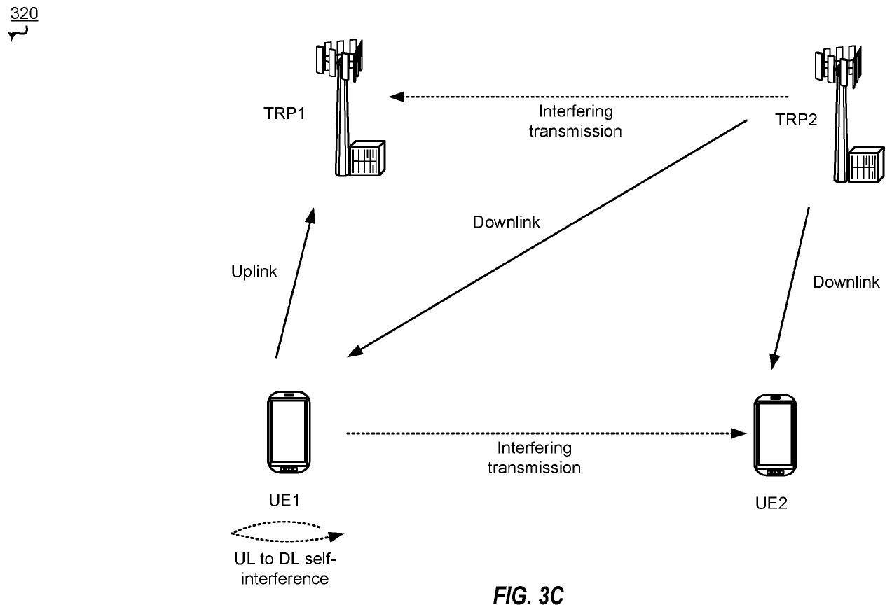

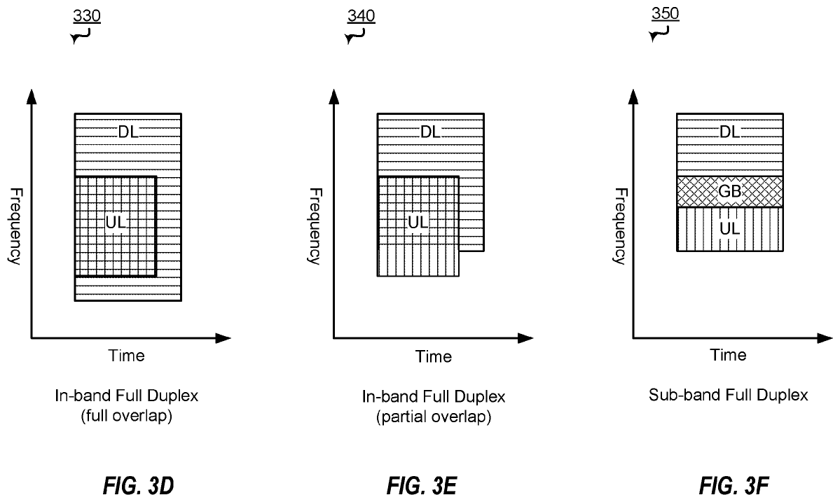

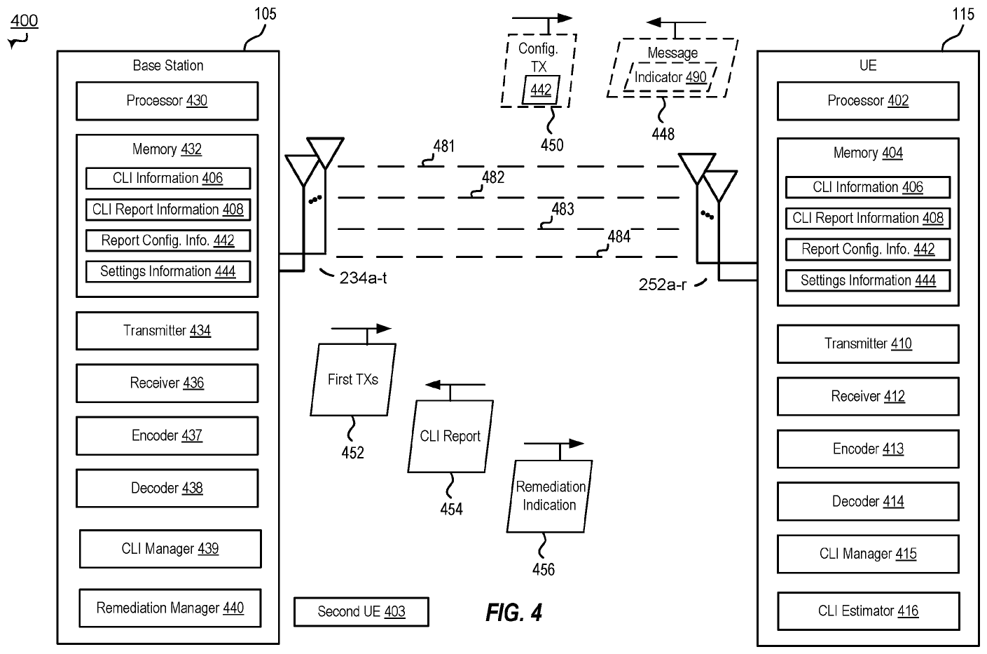

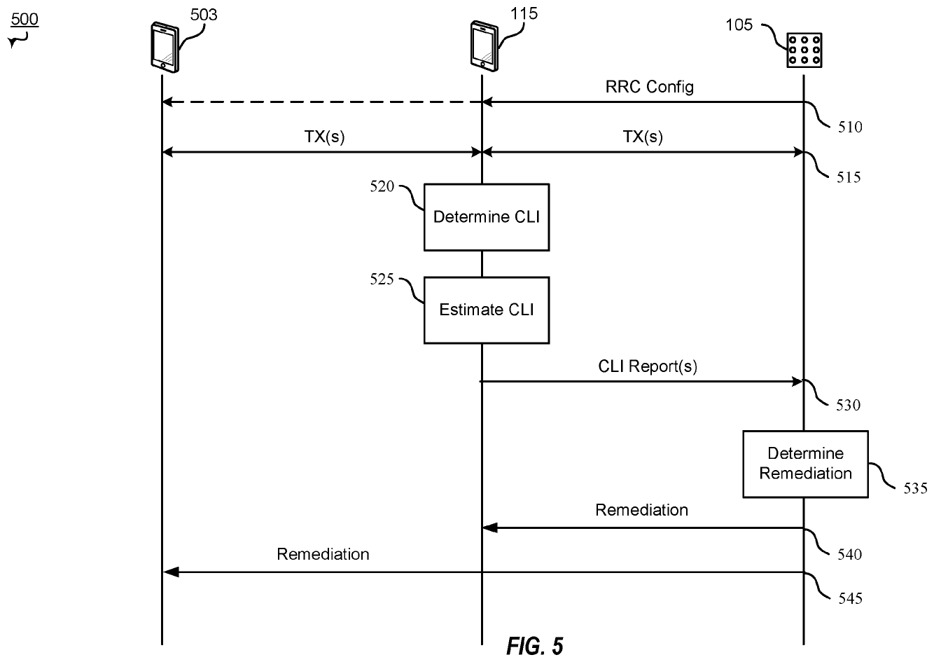

FIGS. 3A, 3B, and 3C illustrate examples of full-duplex communication modes. In FIG. 3A, full-duplex base station and half-duplex UE operations are shown, in FIG. 3B, full-duplex base station and full-duplex UE operations are shown, and in FIG. 3C, full-duplex UE operations (e.g., subband full-duplex (SBFD) UE operations) with a full-duplex base station with multiple TRPs are shown. Full-duplex operation corresponds to transmitting and/or receiving data via multiple antennas at the same time. Half-duplex operation corresponds to transmitting or receiving data via a single antenna at a particular time.

FIGS. 3A, 3B, and 3C depict interference caused from full-duplex operations. To illustrate, external interference (e.g., channel link interference or cross-link interference) and self-interference may be caused during full-duplex operations. External interference is caused from external sources, such as a from a nearby UE or base station. Self-interference is caused by the device itself from performing multiple operations. Self-interference may be caused by leakage, such as when transmitting energy from a transmitting antenna is received by receiving antenna directly or indirectly (e.g., by reflection).

In FIGS. 3A, 3B, and 3C, multiple TRPs are illustrated, such as a first TRP (TRP1) and a second TRP (TRP2). The first and second TRPs may include or correspond to the same base station, such as the same gNB, or to different base stations. In FIGS. 3A, 3B, and 3C, the first TRP (TRP1) may be operating in the same frequency band or in different frequency bands. For example, the first TRP (TRP1) may be operating in a first frequency band, such as FR 4 or 60 GHz, and the second TRP (TRP2) may be operating in a second frequency band, such as FR 2 or 28 GHz.

Additionally, multiple UEs are illustrated in FIGS. 3A, 3B, and 3C, such as a first UE (UE1) and a second UE (UE2) In some implementations, the UE is a full-duplex capable UE with multiple antenna module. FIGS. 3A, 3B, and 3C further depict signal paths between the TRPs and the UES.

Referring to FIG. 3A, FIG. 3A illustrates an example diagram 300 for a first type of full-duplex communication. Referring to FIG. 3A, the diagram 300 illustrates two signal paths (beam paths) between the TRPs and the UEs and example interference. In the example illustrated in FIG. 3A, the first TRP (TRP1) transmits downlink data via a first signal path to the first UE (UE1) and the first TRP (TRP1) receives uplink data via a second signal path from the second UE (UE2). The first TRP and UE experience interference. For example, the first TRP experiences self-interference from simultaneously transmitting and receiving. Additionally, devices receive interference caused by other nearby devices. For example, operations of the second TRP 2 may cause interference at all other nodes, such as the first UE and first TRP as illustrated in FIG. 3A. Additionally, the transmission of uplink data by the second UE may cause interference at the first UE, as shown, and at the second TRP. Operations at the second TRP may also cause interference at other devices, such as at the first TRP as shown in FIG. 3A.

Referring to FIG. 3B, FIG. 3B illustrates an example diagram 310 for a second type of full-duplex communication. Referring to FIG. 3B, the diagram 310 illustrates three signal paths (beam paths) between the TRPs and the UEs and example interference. In the example illustrated in FIG. 3B, the first TRP (TRP1) transmits downlink data via a first signal path to the first UE (UE1) and the first TRP (TRP1) receives uplink data via a second signal path from the first UE (UE1). Additionally, the first TRP (TRP1) transmits downlink data via a third signal path to the second UE (UE2). The first TRP experiences interference. For example, the first TRP experiences self-interference from simultaneously transmitting and receiving and from the operations of the second TRP and UE. Additionally, other devices may receive interference caused by the operation other nearby devices, as described with reference to FIG. 3A.

Referring to FIG. 3C, FIG. 3C illustrates an example diagram 320 for a third type of full-duplex communication. Referring to FIG. 3C, the diagram 320 illustrates three signal paths (beam paths) between the TRPs and the UEs and example interference. In the example illustrated in FIG. 3C, the first TRP (TRP1) receives uplink data via a first signal path from the first UE (UE1). The second TRP (TRP2) transmits downlink data via a second signal path to the first UE and transmits downlink data via a third signal path to the second UE (UE2). The devices may receive interference caused by their own full-duplex operations and/or the operation of other nearby devices, as described with reference to FIGS. 3A and 3B.

FIGS. 3D, 3E, and 3F illustrate examples of full-duplex communication operations. In FIGS. 3D and 3F, in-band full-duplex (IBFD) operations are shown, and in FIG. 3E subband full-duplex operations are shown. In-band full-duplex (IBFD) operation corresponds to transmitting and receiving on the same time and frequency resources. As shown in diagrams 330 and 340 of FIGS. 3D and 3E, the downlink and uplink resources share the same time and frequency resource. The downlink and uplink resources may fully or partially overlap, as shown in FIGS. 3D and 3E respectively. Subband full-duplex operation, often referred to as frequency division duplexing (FDD) or flexible duplex, corresponds to transmitting and receiving data at the same time but on different frequency resources. As shown in diagram 350 of FIG. 3F, the downlink resource is separate from the uplink resource by a relatively “thin” guardband. The guardband in FIG. 3F is enlarged for illustrative purposes. The guardband may also be omitted from SBFD operation in other implementations. Utilizing different frequency domain resources for uplink and downlink is what generally distinguishes SBFD operation from paired spectrum operation (e.g., IBFD operation) in current wireless standard specifications.

While operating in full-duplex provides greatly increased throughput, the increased operations of concurrent transmission and reception cause increased leakage and interference. Specifically, full-duplex operations, such as those of FIGS. 3A-3F, can increase cross-link interference and self-interference which may cause reception errors and channel link failure. Current networks may employ cross-link interference and/or self-interference reporting to alleviate some of the interference and errors. However, current methods are only able to provide to a network a configuration (e.g., particular cell and/or time) which is experiencing material interference, and are not able to indicate a configuration which is not experiencing material interference or predict a configuration which will not experience material interference in the future. Additionally, attempting to measure and report interference for all possible configurations would greatly increase signaling overhead and reduce battery life due to UEs physically measuring interference for additional channels and/or at additional times.

In the aspects described herein, virtual cross-link interference and self-interference determination and reporting are disclosed to enhance the interference information provided to the network and to enable the network to engage in a meaningful remediation action which can avoid or reduce interference, including internal and external interference caused by full-duplex operations. Virtual cross-link interference and self-interference determination includes estimating cross-link interference and self-interference in the frequency and/or time domains from previous interference measurements and/or estimates. This can greatly reduce operations at the UE and reduce battery consumption by reducing the actual interference measuring operations. Additionally, virtual interference estimates for future time slots may enable a network to schedule future transmission which reduce or avoid interference from full-duplex operations.

In addition, enhanced CLI and SI reporting formats are also disclosed to enable efficient signaling of the additional interference information and to provide indications of which CLI measurements or reports are actual (e.g., measured) and which are virtual (e.g., estimated or derived. Thus, devices of the network can more efficiently engage in full-duplex operations with reduced interference. Accordingly, network throughput may be increased and network overhead and errors may be reduced.

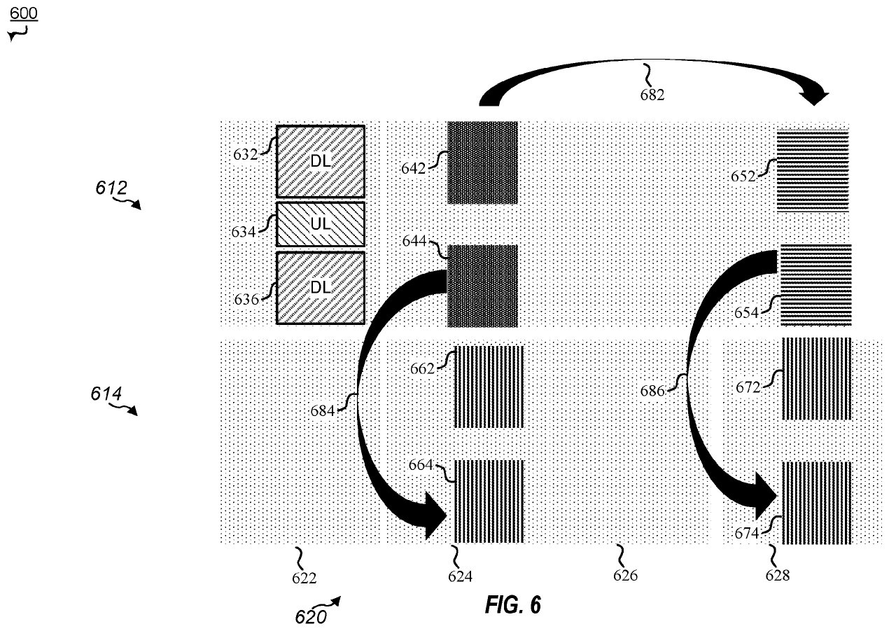

FIG. 4 illustrates an example of a wireless communications system 400 that supports enhanced cross-link interference (CLI) reporting or self-interference (SI) reporting in accordance with aspects of the present disclosure. In some examples, wireless communications system 400 may implement aspects of wireless communication system 100. For example, wireless communications system 400 may include a network, such as one or more network entities, and one or more UEs, such as UE 115 (also referred to as a first UE) and second UE 403. As illustrated in the example of FIG. 4, the network entity includes a corresponds to a base station, such as base station 105. Alternatively, the network entity may include or correspond to a different network device (e.g., not a base station). Enhanced CLI or SI reporting may reduce latency and increase throughput by reducing interference and reception errors and enabling more robust full-duplex operations. Accordingly, network and device performance can be increased.

Base station 105, UE 115, and second UE 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FRI (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105, UE 115, and second UE 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, CLI manager 415, CLI estimator 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store CLI information data 406, CLI report information 408, report configuration information 442, settings data 444, or a combination thereof, as further described herein.

The CLI information 406 includes or corresponds to data associated with or corresponding to CLI. For example, the CLI information 406 may include CLI value information, such as RSRP values, RSSI values, SNR values, SINR values, confidence values, and aggregate value, or a combination thereof. As another example, the CLI information 406 may include historical information or current information (e.g., non-historical information). Additionally, or alternatively, the CLI information 406 may include CLI information for multiple serving cells, multiple subbands, multiple BWPs, multiple CLI report IDs, or a combination thereof.

The CLI report information 408 includes or corresponds to data associated with or corresponding to CLI reports and report transmissions. For example, the CLI report information 408 may include or correspond to one or more CLI reports. A CLI report may include one or more indications or groups of information. To illustrate, a CLI report may include an indication of an actual or virtual CLI report, a bitmap indicating serving cells, serving cell indications identifying one or more serving cells, report type information indication a type of CLI information included, the CLI information itself, one or more indications regarding an amount of reports per cell or group, etc.

The report configuration information 442 includes or corresponds to data indicating or corresponding to CLI report configurations. For example, the report configuration information 442 may include or correspond to report timing information, report type information, report format information, report history length, report resource information, report threshold information, reports per serving cell information, bandwidth part information, subband information, or a combination thereof.

The settings data 444 includes or corresponds to data associated with enhanced CLI or SI reporting operations. The settings data 444 may include one or more types of enhanced CLI or SI reporting operation modes and/or thresholds or conditions for switching between enhanced CLI or SI reporting modes and/or configurations thereof. For example, the settings data 444 may have data indicating different thresholds and/or conditions for different enhanced CLI or SI reporting modes, such as a fixed length field mode, variable length field mode, a CLI only mode, a SI only, a CLI and SI mode, etc., or a combination thereof.

The UE 115 may further include self-interference (SI) information data, such as interference caused by the device on itself. For example, self-interference at the receiver 412 may be caused by concurrent operation of the transmitter 410. The SI information data may include or correspond to SI value information, such as RSRP values, RSSI values, SNR values, SINR values, confidence values, and aggregate value, or a combination thereof. As another example, the SI information data may include historical information or current information (e.g., non-historical information). Additionally, or alternatively, the SI information data may include SI information for multiple serving cells, multiple subbands, multiple BWPs, multiple SI report IDs, or a combination thereof. The SI information data may be included in the CLI information 406 in some implementations.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. CLI manager 415 (or CLI report manager) may be configured to perform CLI determination and reporting operations. For example, CLI manager 415 may be configured to determine and/or measure CLI information for CLI reporting. To illustrate, the CLI manager 415 may determine actual CLI values and generate CLI reports based on the actual or measured CLI values. CLI manager 415 may also be configured to perform SI determination and reporting operations.

CLI estimator 416 may be configured to perform CLI estimation operations, such as CLI prediction, CLI extrapolation, and CLI interpolation. For example, CLI estimator 416 may be configured to estimate CLI values in the time and frequency domains. To illustrate, the CLI estimator 416 may predict CLI values for a future slot based on historical and/or current CLI values for a particular serving cell. As another illustration, the CLI estimator 416 may predict CLI values for a current slot or a future slot based on historical and/or current CLI values for a different serving cell. CLI estimator 416 may also be configured to perform SI estimation operations, such as SI prediction, SI extrapolation, and SI interpolation.

Second UE 403 may include one or more elements similar to UE 115. In some implementations, the UE 115 and the second UE 403 are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, CLI manager 439, remediation manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store CLI information data 406, CLI report information 408, report configuration information 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. CLI manager 439 may include similar functionality as described with reference to CLI manager 415. Remediation manager 440 may be configured to determine CLI remediation operations and perform CLI and/or SI remediation operations. For example, the remediation manager 440 may be configured to determine a remediation action for a base station device or a UE. As another example, the remediation manager 440 may be configured to provide the remediation determination to one or more other devices.

During operation of wireless communications system 400, the network (e.g., base station 105) may determine that UE 115 has enhanced CLI reporting capability. For example, UE 115 may transmit a message 448 that includes an enhanced CLI reporting indicator 490 (e.g., an enhanced CLI reporting capability indicator). Indicator 490 may indicate enhanced CLI reporting capability for one or more communication modes, such as downlink, uplink, etc. In some implementations, a network entity (e.g., a base station 105) sends control information to indicate to UE 115 that enhanced CLI reporting operation and/or a particular type of enhanced CLI reporting operation is to be used. For example, in some implementations, configuration transmission 450 is transmitted to the UE 115. The configuration transmission 450 may include or indicate to use enhanced CLI reporting operations or to adjust or implement a setting of a particular type of enhanced CLI reporting operation. For example, the configuration transmission 450 may include CLI report information 408, report configuration information 442, as indicated in the example of FIG. 4, settings data 444 or any combination thereof.

During operation, devices of wireless communications system 400, perform enhanced CLI reporting operations. For example, the network and UE 115 may exchange transmissions via uplink and/or downlink communications in a full-duplex manner (e.g., SBFD manner) with enhanced CLI reporting as illustrated in the example of FIG. 4. This enhanced CLI reporting enables devices to adjust full-duplex operations to reduce CLI The enhanced CLI reporting may be achieved by reporting virtual CLI reports (estimated CLI reports) in addition to actual CLI reports. These estimated CLI reports may provide additional information for future slots and other serving cells. Additionally, the enhanced CLI reporting may be achieved by reporting indications for the virtual and actual CLI reports to distinguish such CLI reports. Such indications may allow greater flexibility in CLI reporting and reporting multiple CLI reports and types in one transmission.

In the example of FIG. 4, the devices of the network may engage in one or more first transmissions 452. For example, one or more of the base station 105, the UE 115, and/or the second UE 403 may each transmit a transmission of the first transmissions 452. In some implementations, the UE 115 is monitoring for one or more transmissions of the first transmissions 452. The operations of the devices of the network may cause devices of the network, such as UE 115, to experience CLI. In the example of FIG. 4, the UE 115 experiences CLI causes by the first transmissions. The UE 115 determines CLI information 406 based on one or more of the first transmissions 452. The first transmissions 452 may include or correspond to broadcast message, a RRC message, a DCI transmission, a PDCCH, a PDSCH, a PUCCH, a PUSCH, a SCI, a SL-MAC-CE, or a SL-RRC message.

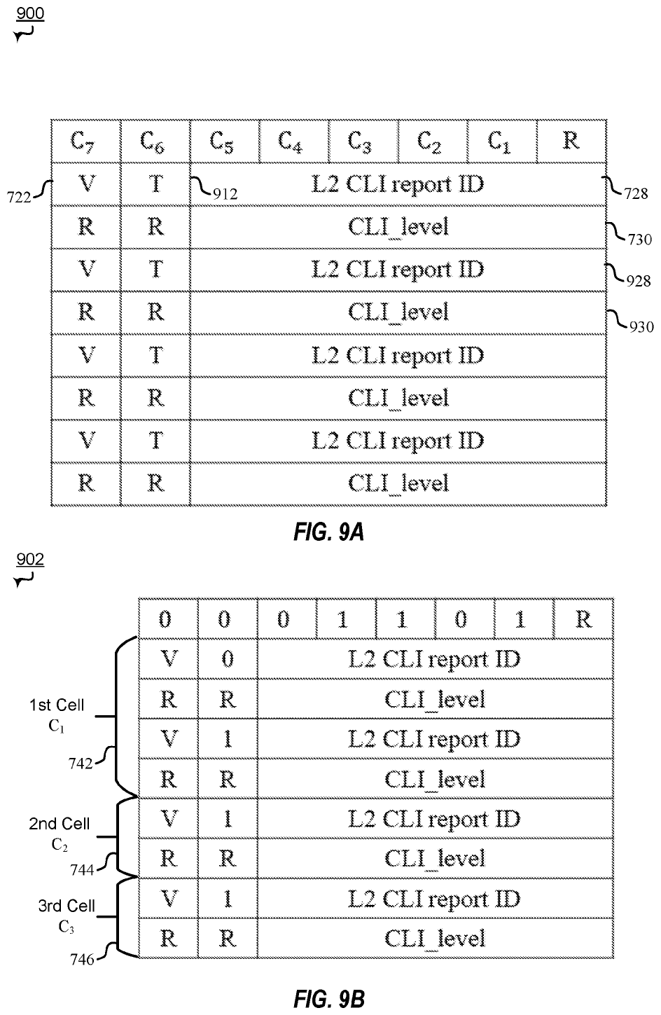

The UE 115 generates CLI report information 408 based on the CLI information 406, and the UE 115 transmits the CLI report information 408 in a CLI report transmission 454 to the base station 105. For example, the UE 115 reports multiple CLI reports in the CLI report transmission 454, each CLI report corresponding to CLI information 406. To illustrate, the UE 115 may report one or more CLI reports per serving cell, one or more actual CLI reports, one or more virtual CLI reports, etc. The UE 115 may determine a configuration or layout of the CLI report transmission 454 based on the report configuration information 442. Exemplary configurations or layouts of the CLI report transmission 454 are illustrated in FIGS. 7A-13B.

The base station 105 receives the CLI report transmission 454. The base station 105, such as the remediation manager 440 thereof, may determine one or more remediation actions based on the CLI report information 408 of the CLI report transmission 454. For example, the base station 105 may parse the CLI report transmission 454 based on a CLI report configuration indicated by the configuration transmission 450 to determine the CLI information 406 of or indicated by the CLI report information 408. The base station 105 may then generate remediation information based on the CLI information 406 or the CLI report information 408. To illustrate, the base station 105 may transmit a remediation indication 456 including a remediation action or the remediation information. The remediation indication 456 may be transmitted to another base station, the UE 115, or the second UE 403.

A device which receives the remediation indication 456 may then adjust a setting or configuration to reduce CLI at the UE 115. For example, the UE 115 receives the remediation indication 456 and may adjust a configured grant, a slot format, a BWP, etc., to avoid CLI. As another example, the UE 115 may adjust a transmission power or beam parameter to reduce the CLI. Additionally, or alternatively, other devices may adjust a configuration or setting to reduce CLI at the UE 115. For example, the second UE 403 may adjust one or more of the configurations or settings discussed above to reduce the CLI at or experienced by the UE 115. Although the example of FIG. 4 is directed to CLI, in other implementations, the devices may additionally or alternatively report and remediate SI. SI may be reported with CLI (e.g., in the same report or transmission) or in addition to CLI (e.g., in another report or transmission).

Accordingly, the network (e.g., the base station 105, the UE 115, and the second UE 403) may be able to more efficiently and effectively make use of available spectrum by resolving issues created by CLI or SI caused by full-duplex operation. Improved spectrum utilization through enhanced CLI or SI reporting may increase throughput and reduce latency, which may lead to reduced link failures. Accordingly, the network performance and experience may be increased due to the increases in speed and reductions in failure.

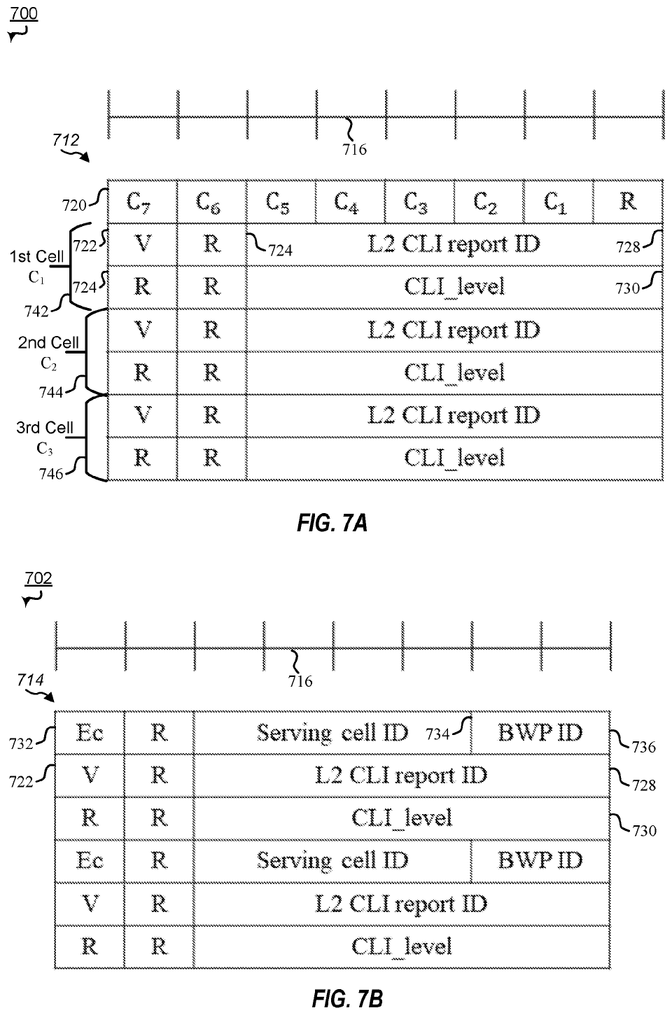

Referring to FIG. 5, FIG. 5 is a timing diagram 500 illustrating a wireless communication system that supports enhanced CLI or SI reporting according to one or more aspects. The example of FIG. 5 corresponds to an example of enhanced CLI or SI reporting for aperiodic or periodic CLI or SI reporting operations.

The example of FIG. 5 includes similar devices to the devices described in FIGS. 1, 2, and 4, such as a UE 115, second UE 503 (e.g., second UE 403) and a network entity (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with per band maximum quantities of resource elements. In some implementations, network entity may include or correspond to multiple TRPs of a single base station (e.g., base station 105), to multiple base stations, or any combination thereof.

At 510, the base station 105 transmits CLI configuration information to the UE 115. For example, the base station 105 may transmit a signaling transmission including CLI configuration information. As illustrated in the example of FIG. 5, the base station 105 transmits RRC signaling (e.g., a RRC transmission or message), including the CLI reporting configuration information, to the UE 115 and optionally the second UE 503.

As described with reference to FIG. 4, the CLI configuration information (e.g., report configuration information 442) may include or indicate CLI report settings and indicate a CLI reporting format, such as CLI reporting format depicted in FIGS. 7A-13B. For example, the CLI configuration information may indicate a CLI reporting transmission type, serving cell information, subband cell information CLI reporting conditions or threshold information, bandwidth part information (e.g., type, or size), CLI reporting type, CLI reporting timing, or a combination thereof. As another example, the CLI configuration information may include information about CLI determination or CLI estimation. To illustrate, the CLI configuration information may indicate CLI measurement resources. The downlink transmission may include or correspond to a RRC message, a MAC-CE, DCI, a PDCCH, or a PDSCH.

After receiving the CLI configuration information, the UE 115 may determine the CLI reporting configuration. For example, the UE 115 may receive and parse the transmission at 510 from the base station 105 to determine the CLI reporting configuration (e.g., report configuration information 442).

At 515, the UE and the second UE 503 may transmit or receive transmissions, such as operate in a full-duplex mode. For example, the second UE 503 may transmit a transmission to the UE 115 and/or the base station 104. The UE 115 may also be transmitting a transmission during this time. Additionally or alternatively, the UE 115 may receive energy form other transmission while monitoring for the transmission from the second UE 503, or may receive energy from the transmission from the second UE 503 while monitoring for transmissions from the base station 105. Accordingly, the UE 115 may experience CLI from or associated with the transmission at 510 from the second UE 503.

At 520, the UE 115 may determine actual CLI information. For example, the UE 115 may determine a CLI measurement resource and determine (e.g., measure) the CLI for the CLI measurement resource to generate an actual, measured, or non-historic CLI value. The actual CLI value may include or correspond to a measured CLI value for an actual received transmission and may be referred to as a current or non-historic value. As will be described in more detail below, the UE 115 may determine or receive an indication of the CLI measurement resource or resources to measure from the network, such as base station 105.

The UE 115 may determine the actual CLI information based on non-historic CLI information corresponding to only the respective serving cell to which the respective CLI measurement corresponds. As an illustrative example, the UE 115 may measure a CLI received signal strength indicator (CLI-RSSI) in a particular slot for a particular serving cell, and generate an actual CLI-RSSI, based on the measured CLI-RSSI, for the particular slot and the particular serving cell Additionally, or alternatively, the UE 115 may determine or measure the CLI based on transmission power information for the transmission and coupling loss (CL) information.

At 525, the UE 115 may determine the estimated CLI information. For example, the UE 115 may determine or estimate CLI based on the actual CLI information and optionally other actual CLI information or estimated CLI information. The estimated CLI indication may include or correspond to a predicted CLI indication in a time domain or an extrapolated or interpolated CLI indication in a frequency domain. The estimated CLI indication is not solely generated based on a measured CLI. As will be described in more detail below, the UE 115 may determine or receive an indication of the CLIs to predict or estimate from the network.

The UE 115 may determine or estimate the virtual CLI information based on at least one of historic CLI information corresponding to only the respective serving cell to which the respective measurement corresponds, or historic or non-historic CLI information corresponding to one or more serving cells different from the respective serving cell to which the measurement corresponds. As an illustrative example, the UE 115 may measure a CLI received signal strength indicator (CLI-RSSI) in a particular slot for a particular serving cell, and predict a CLI-RSSI, based on the measured CLI-RSSI, in a future slot for the particular serving cell to generate a second determined CLI. As another illustrative example, the UE 115 may measure a CLI received signal strength indicator (CLI-RSSI) in one or more serving cells, and extrapolate or interpolate the measured CLI-RSSI to one or more other serving cells to generate a second determined CLI, wherein the CLI report information includes the second determined CLI. Although an example for RSSI is given above, in other implementations, the UE 115 may determine or measure RSRP, SNR, SINR, a confidence value etc., or a combination thereof.

The UE 115 may determine the resources, also referred to as measurement resources, for measuring the CLI based on UE determination or network indication. In implementations in which the network indicates the resources, the UE 115 may receive CLI configuration information indicating CLI measurement resources, wherein the CLI measurement is performed during at least one CLI measurement resource of the CLI measurement resources. For example, the CLI configuration information received at 510 may indicate or identify the resources for the UE 115 to use. Alternatively, in implementations in which the UE 115 determines the resources, the UE 115 may determine one or more CLI measurement resources based on one or more CLI measurement conditions. Optionally, the UE 115 may determine whether to estimate CLI values for additional serving cells or slots based on a window of past measurements or a threshold quantity of past measurements. In some such implementations, the UE 115 may determine the window of past measurements based on a CLI measurement timer.

At 530, the UE 115 transmits CLI report information to the base station 105. For example, the CLI manager 415 of the UE 115 may generate multiple CLI reports and include the CLI reports in a CLI report transmission, and the UE 115 may transmit the CLI report transmission to the base station 104 in an uplink transmission. The CLI report transmission may include one report per serving cell or multiple reports per serving cell. Alternatively, the CLI report transmission may include one CLI report.

In some implementations, the UE 115 may determine whether to report an estimated CLI value based on a threshold confidence level for the estimated CLI value. For example, the UE 115 may generate the CLI report information based on the estimated CLI, such as include the specific estimated CLI value/report in the CLI report information, responsive to a determination that a confidence level for the estimated CLI value is greater than or equal to the threshold confidence level. The UE 115 may refrain from including or exclude one or more particular estimated CLI values/reports in the CLI report information which do not satisfy the threshold confidence level.

At 535, the base station 105 determines remediation information based on receiving the CLI report transmission at 530. For example, the base station 105 may receive and parse the CLI report transmission to determine or identify CLI reports and CLI information thereof. The base station 105, such as the remediation manager 440 thereof, may identify one or more CLI values to remediate, such as based on thresholds or other conditions, and may determine one or more actions to reduce CLI for the identified CLI values. The base station 105 may generate remediation information indicative of the such actions reduce CLI for the identified CLI values.

At 540, the base station 105 may transmit remediation information to the UE 115. For example, the base station 105 may transmit remediation information indicating a particular configuration change for the UE 115. To illustrate, the base station 105 may transmit DCI, a MAC CE, or RRC signaling to indicate a configuration change for the UE 115. The change may include a configuration adjustment or setting modification as described with reference to FIG. 4. As illustrative, non-limiting examples, the change may include a change in slot settings (e.g., slot format), transmission timing (e.g., configured grant timing, dynamic grant timing, etc.), transmission power, beam information, or a combination thereof.

At 545, the base station 105 may transmit remediation information to the second UE 503. For example, the base station 105 may transmit the remediation information or second remediation information to the second UE 503. To illustrate, the base station 105 may transmit the same remediation information to the second UE 503 as it did to the first UE 105 or it may transmit different remediation information to the second UE 503. After receiving the remediation information, one or more of the UEs may modify its operation or a transmission or receive parameter to reduce CLI for the UE 115.

Optionally, the base station 105 may perform one or more additional operations. For example, the base station 105 may not transmit a remediation indication including remediation information and may instead adjust a configuration or setting of the base station 105. Alternatively, the base station 105 may transmit a remediation indication including remediation information to another base station, such as a base station of another cell or cell group. The other base station may then relay the remediation indication (or the remediation information thereof) or transmit a second remediation indication based on the received remediation indication. For example, the other base station may transmit the remediation indication to a UE of another cell group to reduce CLI caused by inter-UE CLI from another cell group (inter-cell CLI).

Although the example of FIG. 5 is described with reference to CLI, in other implementations, the devices may report CLI and SI or just SI. For example, the UE 115 may determine one or more actual and/or virtual SI values and the base station 105 may determine remediation actions to reduce SI at the UE 115. Accordingly, in the example, of FIG. 5, devices of the network may be able to have a more flexible utilization of full-duplex slot configurations through the use of enhanced CLI or SI reporting.

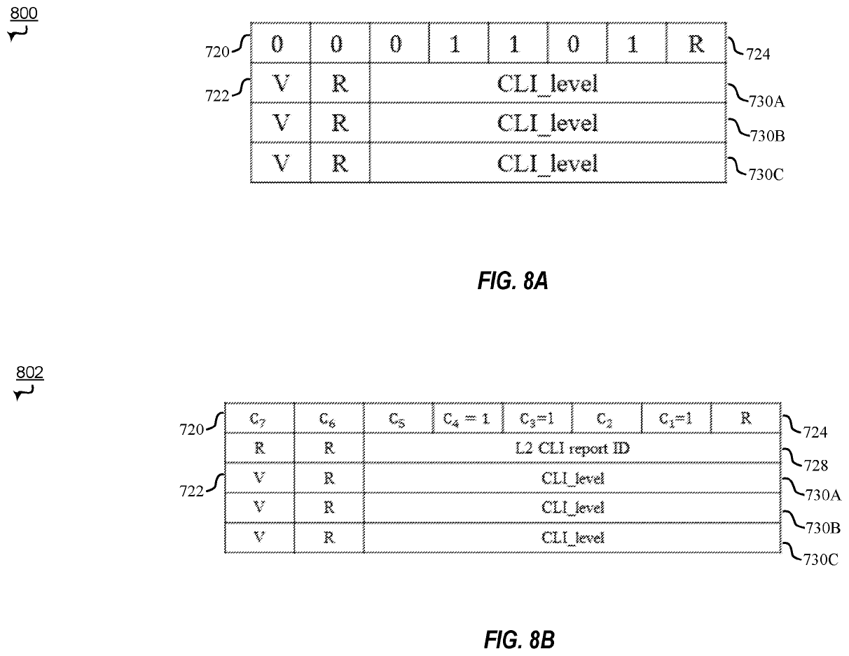

Referring to FIG. 6, FIG. 6 is a block diagram 600 illustrating an example of CLI estimation according to one or more aspects. The example of FIG. 6 may include or correspond to an example of CLI prediction an CLI extrapolation or interpolation by a UE, such as UE 115. As described above, estimation of CLI may include estimation of CLI based on non-historic CLI information corresponding to only the respective serving cell to which the respective CLI report corresponds; historic CLI information corresponding to only the respective serving cell to which the respective CLI report corresponds; or historic or non-historic CLI information corresponding to one or more serving cells different from the respective serving cell to which the respective CLI report corresponds.

In the example of FIG. 6, the block diagram 600 depicts transmission bands (also referred to as bands) for two component carriers (also referred to as serving cells) over four time periods. The two component carriers include a first component carrier 612 (CC1) and a second component carrier 614 (CC0). In the example of FIG. 6, the four time periods include a first slot 622, a second slot 624, a third slot 626, and a fourth slot 628.

Each band may have a number of subbands. In the example of FIG. 6, the transmission band, such as the bandwidth thereof, includes one uplink subband 634 positioned between two downlink subbands, a first downlink subband 632 and second downlink subband 636. Although the subbands 632-636 are shown overlaid on the band of first component carrier 612 (CC1) for the first slot 622, in FIG. 6 each slot has the same subband configuration.

During operation, a device may determine an actual CLI measurement for a particular channel, such as particular component carrier, and for a particular time, such as particular slot. As illustrated in the example of FIG. 6, a device determines, such as measures, the CLI for the two downlink subbands (632 and 636) of the first component carrier 612 during the second slot 624. The measuring of the CLI generates an actual CLI measurement, and an actual CLI value may be determined as or based on the actual CLI measurement. To illustrate, the device determines a first actual CLI 642 (non-historic CLI) and a second actual CLI 644 based on the measurements of the two downlink subbands (632 and 636) of the first component carrier 612 during the second slot 624.

In some implementations, the device may determine, such as estimate or predict a CLI measurement for other combinations of carriers and slots. As illustrated in the example of FIG. 6, the device determines, such as estimated or predicts, multiple virtual CLIs based on historic CLI information or non-historic CLI information for another component carrier. For example, the device may estimate a first virtual CLI 652 for the first downlink subband 632 and the fourth slot 628 based on the first actual CLI 642 for the second slot 624, and the device may estimate a second virtual CLI 654 for the third downlink subband 636 and the fourth slot 628 based on the second actual CLI 644 for the second slot 624. The generation of the first and second virtual CLIs 652 and 654 may be referred to as predicted CLIs or estimated CLIs in the time domain. That is, the virtual CLIs are estimated based on historic or prior measurements for earlier slots on the same component carrier.

As another example, the device may estimate a third virtual CLI 662 for a corresponding first downlink subband of the second component carrier 614 during the second slot 624 based on the first actual CLI 642, and the device may estimate a fourth virtual CLI 664 for a corresponding second downlink subband of the second component carrier 614 during the second slot 624 based on the second actual CLI 642. The generation of the third and fourth virtual CLIs 662 and 664 may be referred to as extrapolated or interpolated CLIs or estimated CLIs in the frequency domain. That is, the virtual CLIs are estimated based on non-historic or current measurements on a different component carrier.

In a some such implementations, the virtual CLIs may be generated based on additional CLIs. To illustrate, the virtual CLIs can be determined based on historic CLIs for a different component carrier or based on both historical CLIs for the same component carrier and current CLIs for a different component carrier. For example, a fifth virtual CLI 672 may be determined based on the first virtual CLI 652, and a sixth virtual CLI 674 may be determined based on the second virtual CLI 654.

Although the example of FIG. 6 is described with reference to CLI, in other implementations, the devices may estimate SI similar to techniques described for CLI. For example, the UE 115 may determine predict or extrapolate/interpolate virtual SI values in the time and/or frequency domains.

Examples of different formats for reporting CLI report information are illustrated in FIGS. 7A-13B. FIGS. 7A-13B each illustrate a block diagram of an exemplary CLI reporting format structure illustrating a layout of different groups of bits (e.g., fields) which comprise the CLI report information. As illustrative examples, two different formats are illustrated for indicating or identifying a serving cell associated with a CLI report of the CLI information. A first format, as illustrated in FIG. 7A, includes a bitmap which identifies serving cells, such as by an association to configured serving cells, such as indicated by list of serving cells configured for the device. A second format, as illustrated in FIG. 7B, includes one or more serving cell identifier indications (e.g., serving cell identifier (ID) fields) for indicating or identifying a serving cell associated with a CLI report of the CLI information.

Referring to FIG. 7A, a first example 700 of a CLI report format for reporting or indicating CLI report information is illustrated. In the first example 700, the CLI report format includes seven (7) octets (e.g., rows) of eight (8) bits. A bit marker 716 is also illustrated in FIG. 7A along with the CLI report format to identify the bits of the octets and indicate a quantity of bits of each group of bits or field.

A first octet of the CLI report format includes a bitmap 720 for indicating which serving cells have a CLI report in the CLI report information, where each respective bit of the bitmap 720 indicates whether the CLI report includes a respective report corresponding to a respective serving cell of the one or more serving cells. As illustrated in the example of FIG. 7A, the bitmap 720 may include or correspond to a Ci field. The Ci field may be used to indicate a presence of CLI reports and additional octets and fields. For example, a first bit value may indicate a CLI report is included and a second bit value may indicate not CLI report is included for the corresponding serving cell. Although the Ci field is seven bits long in the example of FIG. 7A, the Ci field may be longer or shorter in other examples.

The CLI report format is capable of including or indicating a plurality of CLI and/or SI reports, such as one CLI report and/or one SI report for each serving cell identified in the bitmap 720. In implementations where SI is included and separate from CLI, a second bitmap similar to bitmap 720 may be included for indicating a presence of a SI report.

In the example of FIG. 7A, the CLI report format supports one CLI report per serving cell. In other examples, such as the examples of FIGS. 9A-10B, other CLI report formats may support multiple CLI reports per serving cell. Each CLI report may include a group of bits for reporting a CLI value and one or more groups for reporting CLI report types. For example, rows two and three (octets two and three) correspond to a first CLI report for a first serving cell 742, such as C1. The group of bits for reporting a CLI value may include or correspond to a CLI value field 730 (e.g., CLI level field).

The first CLI report includes a first report type indication and a second report type indication. The first report type indication (e.g., virtual indication bit or V-bit) is indicative of whether the CLI information includes actual CLI information or virtual (e.g., estimated) CLI information. As illustrated in the example of FIG. 7A, the CLI report format includes a first report type indication field 722 (e.g., V bit indicator) for indicating the first report type indication and a second report type indication field 728 for indicating the second report type indication. The second report type indication (e.g., CLI Report ID field) is indicative of a report type or report identifier (ID). In some implementations, the CLI report format includes one or more reserve or reserved bits, 726.

Referring to FIG. 7B, a second example 702 of a CLI report format for reporting or indicating CLI report information is illustrated. In the second example 702, the CLI report format includes six (6) octets (e.g., rows) of eight (8) bits. The bit marker 716 is also illustrated in FIG. 7B along with the CLI report format to identify the bits of the octets and indicate a quantity of bits of each group of bits or field.

As compared to the first example 700 of FIG. 7A, the second example 702 of FIG. 7B includes many of the same indications and fields as the first example 700 of FIG. 7A. For example, the second example 702 includes virtual or actual report indications (e.g., 722), CLI report type indications (e.g., 728), CLI value indications (e.g., 730), reserve bits (e.g., 724), etc. However, the second example 702 of FIG. 7B does not include a bitmap 720. Rather, the second example 702 of FIG. 7B includes one or more extension indications and one or more indications of serving cell identifiers, such as a serving cell identifier field 734. To illustrate, the CLI reporting format of the second example 702 explicitly includes or identifies the serving cells of the CLI reports included in the CLI report information, and extension indications 732 (e.g., an Ec bit or field) are configured to indicate if additional CLI reports are included. For example, a first bit value (e.g., 1) indicates at least one additional CLI report is included, and a second bit value (e.g., 0) indicates no additional CLI report are included or that the current CLI report is a last CLI report of the CLI report information.

In some implementations, the CLI reporting format of the second example 702 further includes bandwidth part (BWP) indications, such as BWP identifier indications. As illustrated in the example of FIG. 7B, the CLI reporting format includes a BWP indication for each CLI report and the BWP indication is included in a BWP ID field 736 which is located in the same octet as the serving cell identifier indication and field. The BWP indication may indicate or identify a BWP associated with the CLI report and value. The BWP field enables the UE to report CLI values for different BWPs.

Referring to FIGS. 8A and 8B, example CLI reporting formats are illustrated which support a single report ID configuration. In FIG. 8A, a single CLI report ID is used and is indicated by separate signaling, such as preconfigured. In FIG. 8B, the CLI reporting format includes a single CLI report ID indication for indicating a report ID configuration for all servings cells or all CLI reports.

In FIG. 8A, a third example 800 of a CLI reporting format is illustrated. The third example 800 depicts a CLI reporting format which is reporting the CLI reports for three serving cells, a first CLI report for a first serving cell, a second CLI report for a second serving cell, and a third CLI report for a third serving cell. To illustrate, a bitmap 720 of the third example indicates that the CLI report information includes a CLI report for a first serving cell (C1), a third serving cell (C3), and a fourth serving cell (C4). Specifically, the third example 800 includes a first CLI report for the first serving cell, a second CLI report for the third serving cell, and a third CLI report for the fourth serving cell. The first CLI report has a first CLI value indicated by a first CLI value field 730A, the second CLI report has a second CLI value indicated by a second CLI value field 730B, and the third CLI report has a third CLI value indicated by a third CLI value field 730C.

Each of the first CLI report, the second CLI report, and the third CLI report have the same CLI report type. However, the CLI report type is static and is preconfigured by the network or region in the third example 800. To illustrate, the CLI reporting format does not include a CLI report ID indication (e.g., CLI report ID field) which indicates a CLI report type for every CLI report included in the CLI report information as in the previous examples of FIGS. 7A and 7B. Rather, the network or device manufacture may indicate the CLI report type to the UE prior to generation and transmission of the CLI report. Such formats which lack explicit indication of CLI report type may greatly reduce CLI overhead. A network can still change the CLI report type or a UE can cycle through CLI report types in subsequent CLI reports.

In FIG. 8B, a fourth example 802 of a CLI reporting format is illustrated. The fourth example 802 depicts a CLI reporting format which is reporting CLI reports for three serving cells, a first CLI report for a first serving cell, a second CLI report for a third serving cell, and a third CLI report for a fourth serving cell. Similar to the third example 800 of FIG. 8A, each of the first CLI report, the second CLI report, and the third CLI report have the same CLI report type. However, the fourth example 802 of the CLI reporting format of FIG. 8B includes an indication of the CLI report type. To illustrate, a second octet of the CLI reporting format includes a single CLI report ID indication (e.g., CLI report ID field) which indicates a CLI report type for every CLI report included in the CLI report information. As compared to the static CLI report type of the third example 800 of FIG. 8A, the fourth example 802 of FIG. 8B enables dynamic adjustment of the CLI report type and give the UE flexibility in reporting CLI (and/or SI).

Although the example CLI reporting formats of FIGS. 8A and 8B include bitmaps for indicating serving cell information or indications, in other implementations, a CLI reporting format may utilize the serving cell identifier indications of FIG. 7B with either no CLI report ID indication as in FIG. 8A or a single CLI report ID indication as in FIG. 8B.

Referring to FIGS. 9A and 9B and FIGS. 10A and 10B, example CLI reporting formats are illustrated which support multiple CLI reports per serving cell. FIGS. 9A and 9B have a CLI reporting format similar to the first example 700 of FIG. 7A, and FIGS. 10A and 10B have a CLI reporting format similar to the second example 702 of FIG. 7B. For example, FIGS. 9A and 9B use a bitmap for indicating serving cells and which serving cells have CLI reports, and FIGS. 10A and 10B use a serving cell identifiers for indicating serving cells.

In FIG. 9A, a fifth example 900 of a CLI reporting format is illustrated. The fifth example 900 depicts a CLI reporting format which utilizes a bitmap for serving cell indication and has a similar structure to the first example 700 of FIG. 7A. However, in the fifth example 900 of FIG. 9A, the CLI reporting format further includes one or more termination indications. Specifically, the CLI reporting format includes a termination bit 912 for each CLI report in the example of FIG. 9A. As compared to first example 700 of FIG. 7A, the termination bit 912 utilizes or replaces one of the previous reserve bits of the octets which include the CLI report ID field. Based on a value of the termination bit 912, the CLI reporting format includes a second octet for the corresponding CLI report for the serving cell which includes the CLI value information (e.g., CLI level field).

Referring to FIG. 9B, an example 902 of the CLI report format of FIG. 9A is provided. In the example 902 of FIG. 9B, a value of 1 for the termination bit (T bit) indicates that the corresponding CLI report is the last CLI report for the respective serving cell and a value of 0 for the termination bit (T bit) indicates that the corresponding CLI report is not last CLI report for the serving cell and that at least one more CLI report is included in the reporting information for the respective serving cell.

To illustrate, the CLI reporting format of FIG. 9B includes one or more CLI reports for three serving cells, such as for C1, C2, and C3. The first serving cell includes multiple (e.g., two) CLI reports and the second and third serving cells each include a single CLI report. A first CLI report for the first serving cell corresponds to the second and third octets or rows and the second CLI report corresponds to the fourth and fifth octets or rows. In the example of FIG. 9B, a value of a first termination bit 912A is 0, and thus the first termination bit 912A indicates a negative termination indication and that at least one additional CLI report is included for the first serving cell. A value of a second termination bit 912B is 1, and thus the second termination bit 912B indicates a positive termination indication and that the corresponding second CLI report is a last CLI report for the first serving cell. The values of third and fourth termination bits 912C and 912D are also 1, as each of the second and third serving cell only have a single CLI report.

Referring to FIGS. 10A and 10B, example CLI reporting formats are illustrated which support a single report ID configuration. In FIG. 8A, a single CLI report ID is used and is indicated by separate signaling, such as preconfigured. In FIG. 8B, the CLI reporting format includes a single CLI report ID indication for indicating a report ID configuration for all servings cells or all CLI reports.

In FIG. 10A, a sixth example 1000 of a CLI reporting format is illustrated. The sixth example 1000 depicts a CLI reporting format which utilizes serving cell identifiers for serving cell indication and has a similar structure to the second example 702 of FIG. 7B. However, in the sixth example 1000 of FIG. 10A, the CLI reporting format further includes one or more termination indications. Specifically, the CLI reporting format includes a termination bit 912 for each CLI report in the example of FIG. 10A. As compared to second example 702 of FIG. 7B, the termination bit 912 utilizes or replaces one of the previous reserve bits of the octets which include the CLI report ID field. Based on a value of the termination bit 912, the CLI reporting format includes a second octet for the corresponding CLI report for the serving cell which includes the CLI value information (e.g., CLI level field).

Referring to FIG. 10B, an example 1002 of the CLI report format of FIG. 10A is provided. In the example 1002 of FIG. 10B, a value of 1 for the termination bit (T bit) indicates that the corresponding CLI report is the last CLI report for the respective serving cell and a value of 0 for the termination bit (T bit) indicates that the corresponding CLI report is not last CLI report for the serving cell and that at least one more CLI report is included in the reporting information for the respective serving cell.

To illustrate, the CLI reporting format of FIG. 10B includes one or more CLI reports for two serving cells, such as for C1 and C2. The first serving cell includes multiple (e.g., two) CLI reports and the second serving cell includes a single CLI report. A first CLI report for the first serving cell corresponds to the second and third octets or rows and the second CLI report corresponds to the fourth and fifth octets or rows. In the example of FIG. 10B, a value of a first termination bit 912A is 0, and thus the first termination bit indicates a negative termination indication and that at least one additional CLI report is included for the first serving cell. A value of a second termination bit 912B is 1, and thus the second termination bit indicates a positive termination indication and that the corresponding second CLI report is a last CLI report for the first serving cell. The value of a third termination bit 912C is also 1, as the second serving cell only has a single CLI report.

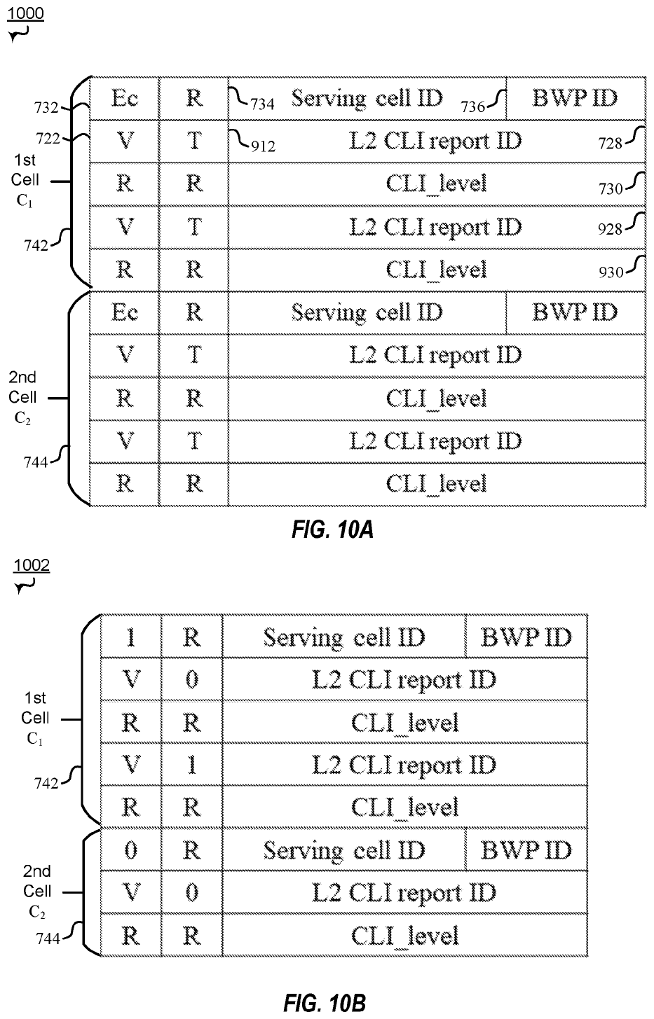

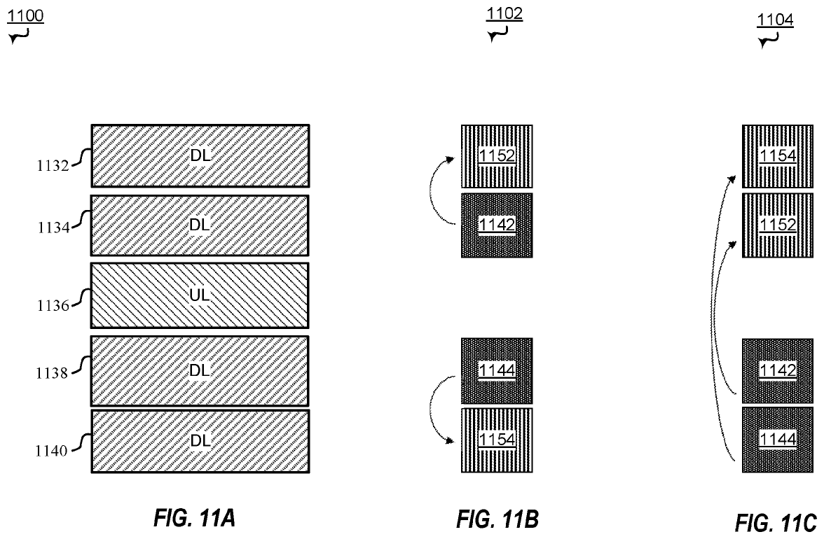

Referring to FIGS. 11A-11C, examples of CLI subband estimations are illustrated. In FIG. 11A, a subband configuration 1100 for a particular serving cell is illustrated. In FIG. 11B, a first example of same-side CLI estimation for subband extrapolation is illustrated, and in FIG. 11C, a second example of cross-side CLI estimation for subband extrapolation is illustrated.

In FIG. 11A, the subband configuration 1100 for a particular serving cell is illustrated which has five subbands, one uplink subband positioned between four downlink subbands. As illustrated in the example of FIG. 11A, the subband configuration includes a first downlink subband 1132, second downlink subband 1134, an uplink subband 1136, third downlink subband 1138, or fourth downlink subband 1140.

In FIG. 11B, a first CLI extrapolation example 1102 is illustrated. The first CLI extrapolation example 1102 includes measuring two CLI values and determining actual CLI values based on the measurements, and generating two virtual CLI values based on extrapolating a corresponding actual CLI value. As illustrated in the example of FIG. 11B, a first CLI measurement 1142 is generated for the second downlink subband 1134 based on CLI measurements for the second downlink subband 1134, and a second CLI measurement 1144 is generated for the fourth downlink subband 1140 based on CLI measurements for the fourth downlink subband 1140. After generation of the actual CLI values, virtual or estimated CLI values may be determined at least based on the actual CLI values.

The first CLI extrapolation example 1102 of FIG. 11B includes same side extrapolation. That is, a first CLI estimation 1152 is generated for the first downlink subband 1132 based on the first CLI value or the first CLI measurement 1142 for the second downlink subband 1134, and a second CLI estimation 1154 is generated for the third downlink subband 1138 based on the second CLI value or the second CLI measurement 1144 for the fourth downlink subband 1140. Additional virtual or estimated CLI values may be determined at least based on the actual CLI values and/or the estimated CLI values.

In FIG. 11C, a second CLI extrapolation example 1104 is illustrated. Similar to the first CLI extrapolation example 1102, the second CLI extrapolation example 1104 includes measuring two CLI values and determining actual CLI values based on the measurements, and generating two virtual CLI values based on extrapolating a corresponding actual CLI value. As illustrated in the example of FIG. 11C, a first CLI measurement 1142 is generated for the third downlink subband 1138 based on CLI measurements for the third downlink subband 1138, and a second CLI measurement 1144 is generated for the fourth downlink subband 1140 based on CLI measurements for the fourth downlink subband 1140. After generation of the actual CLI values, virtual or estimated CLI values may be determined at least based on the actual CLI values.

The second CLI extrapolation example 1104 of FIG. 11C includes opposite or cross-side extrapolation. That is, a first CLI estimation 1152 is generated for the second downlink subband 1134 based on the first CLI value or the first CLI measurement 1142 for the third downlink subband 1138, and a second CLI estimation 1154 is generated for the first downlink subband 1132 based on the second CLI value or the second CLI measurement 1144 for the fourth downlink subband 1140. Additional virtual or estimated CLI values may be determined at least based on the actual CLI values and/or the estimated CLI values.

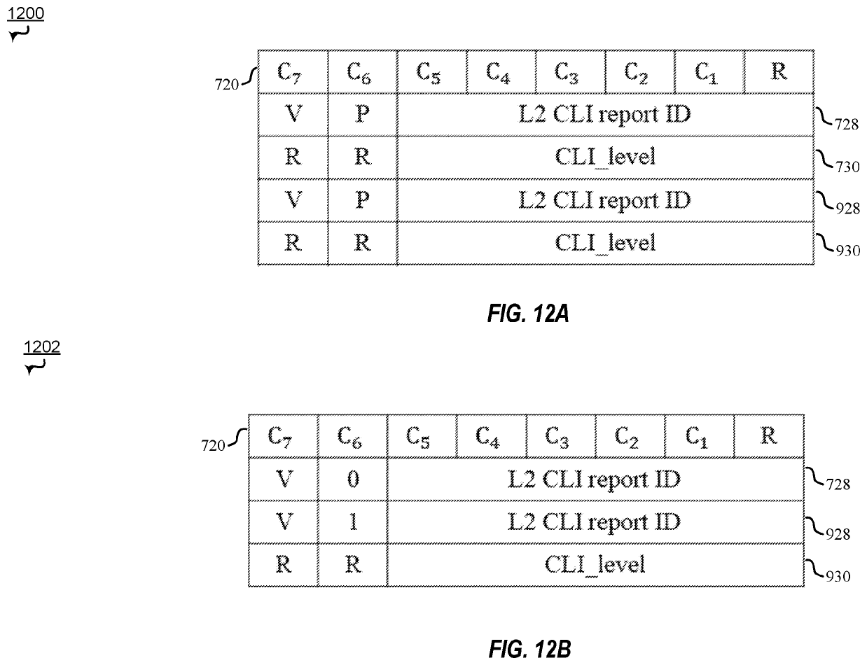

Referring to FIGS. 12A and 12B and FIGS. 13A and 13B, example CLI reporting formats are illustrated which support selective inclusion of CLI value information. For example, CLI level fields for one or more serving cells may be excluded or omitted from the CLI reporting format to save space based on one or more conditions. The exclusion of CLI fields is signaled by an indication, such as separate indicator or field, or by a particular value of an existing field. In some implementations, it may be useful to inform the network or other devices that there is no interference (or no material or actionable interference, such as interference below a threshold level) for a certain CLI report or certain CLI report ID.

Such an indication of no CLI value or level is different from indicating no CLI report is present, such as by the serving cell bit map (Ci field) indicating no CLI report is present. To illustrate, a UE may not include a particular CLI report in the CLI report information and transmission for a particular serving cell when there is no measurement for the serving cell or when the or UE hasn't finished the CLI measurement when generating the CLI report information. Alternatively, in the examples of FIGS. 12A-13B, a UE can include CLI reports in the CLI report information, but exclude CLI value or level information for such CLI reports which satisfy one or more conditions (e.g., have CLI values below a threshold value). Thus, including a CLI report, but indicating no CLI (or SI) value for the report, may reduce overhead while also providing information (e.g., positive CLI indication) to the network.

In FIG. 12A, the CLI reporting format includes a P bit 1212 for indicating if a CLI value (e.g., CLI value field, such as CLI level) is included in the CLI reporting format. In FIG. 12B, an example of the CLI report format of FIG. 12A is provided.

Referring to FIG. 12A, a seventh example 1200 of a CLI reporting format is illustrated. The seventh example depicts a CLI reporting format which utilizes a bitmap for serving cell indication and has a similar structure to the first example 700 of FIG. 7A. However, in the seventh example 1200 of FIG. 12A, the CLI reporting format further includes one or more CLI value indications, such as one for each CLI report or serving cell. Specifically, the CLI reporting format includes a P bit 1212 for each CLI report in the example of FIG. 12A. As compared to first example 700 of FIG. 7A, the P bit 1212 utilizes or replaces one of the previous reserve bits of the octets which include the CLI report ID field. Based on a value of the P bit 1212, the CLI reporting format includes a second octet for the corresponding CLI report for the serving cell which includes the CLI value information (e.g., CLI level field).

Referring to FIG. 12B, an example of the CLI report format of FIG. 12A is provided. In the example of FIG. 12B, a value of 1 for the P bit 1212 indicates the CLI report includes a CLI value and a value of 0 for the P bit 1212 indicates the CLI report does not include a CLI value. To illustrate, the CLI reporting format of FIG. 12B includes two CLI reports, such as for C1 and C2. The first CLI report corresponds to a single octet (the second octet or row) and the second CLI report corresponds to two octets (the third and fourth octets or rows). The UE signals or indicates that the CLI reporting format does not include a CLI value (CLI level field) for the first CLI report based on a first P bit 1212A having a value of 0. The UE signals or indicates that the CLI reporting format does include a CLI value (CLI level field) for the second CLI report based on a second P bit 1214A having a value of 1.

Referring to FIGS. 13A and 13B, additional example CLI reporting formats are illustrated which support selective inclusion of CLI value information. In FIGS. 13A and 13 B, the CLI reporting format uses a value of the CLI report ID field to indicate if a CLI value (e.g., CLI value field, such as CLI level) is included in the CLI reporting format. For example, a value of all zeroes may be used, such as 000000 or 0000000, for the CLI report ID field to indicate in the CLI report type or configuration field that no CLI level field is included. As illustrated, such as format may save one octet per serving cell or per CLI report.

In FIG. 13A, an eighth example 1300 of a CLI reporting format is illustrated. The eighth example depicts a CLI reporting format which utilizes a bitmap for serving cell indication and has a similar structure to the first example 700 of FIG. 7A. However, in the eighth example 1300 of FIG. 13A, the CLI reporting format further includes one or more CLI value indications, such as one for each CLI report or serving cell. Specifically, the CLI reporting format of FIG. 13A increases a size of the CLI report ID field 1312 and uses a special value of the CLI report ID field 1312 to indicate if a CLI value (e.g., CLI value field, such as CLI level) is not included for each CLI report. As compared to first example 700 of FIG. 7A, the CLI report ID field 1312 has 1 extra bit, 7 instead of 6, and this extra bit may accommodate an additional special value or values to provide an additional indication or indications. When the CLI report ID field 1312 has a value which indicates a particular CLI report type, a corresponding CLI value (CLI level field) for the respective CLI report is included in the CLI report format. When the CLI report ID field 1312 has a special value which does not indicate a particular CLI report type, the corresponding CLI value (CLI level field) for the respective CLI report is excluded from the CLI report format. An example is provided in FIG. 13B.

Referring to FIG. 13B, an example of the CLI report format of FIG. 13A is provided. In the example of FIG. 13B, a value of 0000000 for the CLI report ID field 1312 indicates that the CLI report does not include a CLI value. To illustrate, the CLI reporting format of FIG. 13B includes two CLI reports, such as for C1 and C2. The first CLI report corresponds to a single octet (the second octet or row) and the second CLI report corresponds to two octets (the third and fourth octets or rows). The UE signals or indicates that the CLI reporting format does not include a CLI value (CLI level field) for the first CLI report based on a first CLI report ID field 1312A having a value of 0000000. The UE signals or indicates that the CLI reporting format does include a CLI value (CLI level field) for the second CLI report based on a second CLI report ID field 1312B having a value other than 0000000, such as 0101010.

Additionally, although both options for selective inclusion of CLI values of FIGS. 12A-13B are shown with a bitmap 720 for serving cell indication, in other implementations serving cell ID field type reporting formats may be used. For example, the reporting formats of FIG. 7B may be used. In some such implementations, the report format may further include a BWP field.

In some implementations, the UE or network may use or set a threshold for reporting CLI values or including a CLI report or value into the CLI report information or transmission. For example, the UE may measure or estimate a particular CLI, such as for a serving cell or subband, and compare that CLI value to a threshold. The UE then may only report CLI values which are above a threshold. In such implementations, the UE may use any of the report formats (e.g., MAC CE or Layer 2 formats) previously described.

Additionally, the UE or network may set multiple or conditions or threshold in some implementations. For example, the UE or network may set a condition (or conditions) for each serving cell individually. To illustrate, serving cell A may have a first condition which is different from serving cell B, and as an illustrative example, such may be based on distance or transmit power. As another example, the UE or network may set a condition for each serving cell group. Additionally, or alternatively, the UE or network may set different conditions for measured CLIs versus estimated CLIs, and optionally different conditions for predicted CLIs verses interpolated and/or extrapolated CLIs. The network may set the condition or threshold, such as by RRC configuration, or may indicate to the UE how to calculate the condition or threshold. Alternatively, the UE may determine the condition or threshold based on UE criteria or standards or regions settings.

Although the examples of FIGS. 7A-13B are directed to CLI, in other implementations, the devices may use the same or similar reporting formats for SI. SI may be reported with CLI (e.g., in the same report or transmission) or in addition to CLI (e.g., in another report or transmission).

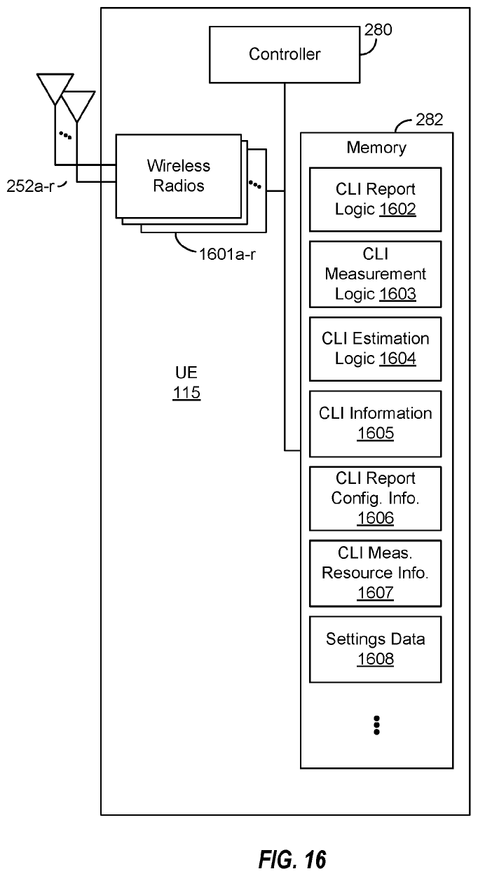

FIG. 14 is a flow diagram illustrating example blocks executed by a wireless communication device (e.g., a UE or base station) configured according to an aspect of the present disclosure. The example blocks will also be described with respect to UE 115 as illustrated in FIG. 16. FIG. 16 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1601a-r and antennas 252a-r. Wireless radios 1601a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 16, memory 282 stores CLI report logic 1602, CLI measurement logic 1603, CLI estimation logic 1604, CLI information data 1605, CLI report configuration information data 1606, CLI measurement resource information data 1607, and settings data 1608. The data (1602-1608) stored in the memory 282 may include or correspond to the data (406, 408, 442, and/or 444) stored in the memory 404 of FIG. 4.

At block 1400, a wireless communication device, such as a UE, generates cross-link interference (CLI) information corresponding to cross-link interference, where the cross-link interference corresponds to one or more serving cells. For example, the UE (e.g., UE 115) may determine CLI Information 406 based on measuring or monitoring for transmissions during the first transmissions 452 of FIG. 4.

The CLI information may include or correspond to the CLI Information 406 of FIG. 4 or the CLI report information 408 of FIG. 4. To illustrate, UE 115 receives one or more of the first transmissions 452 via wireless radios 1601a-r and antennas 252a-r and the CLI manager 415 may determine one or more actual CLI value based on the transmissions. As another illustration, the CLI estimator 416 may determine one or more virtual CLI values based on the transmissions.

At block 1401, the UE transmits CLI report information including one or more CLI reports, wherein each CLI report of the one or more CLI reports corresponds to a respective serving cell of the one or more serving cells. Each CLI report of the one or more CLI reports includes respective CLI information of the CLI information corresponding to the respective serving cell to which the respective CLI report correspond. Each CLI report of the one or more CLI reports includes a respective report type indication, and each respective report type indication is indicative of whether the respective CLI information included in the respective CLI report to which it corresponds includes respective actual CLI information or respective estimated CLI information. For example, the UE 115 may transmit the CLI report information to a network device, such as base station 105. The CLI report information may include or correspond to one or more of the CLI report transmission 454 of FIG. 4, or the CLI reporting transmission, as described with reference to FIG. 5. To illustrate, a transmitter (e.g., transmit processor 264 or transmitter 410) of the UE 115 transmits the CLI report transmission 454 via wireless radios 1601a-r and antennas 252a-r using the transmission bandwidth for the transmission.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 4, 5, 6, 11A, and 11B. As another example, the wireless communication device (e.g., the UE 115) may perform one or more aspects as presented below.

In a first aspect, respective actual CLI information is based on respective non-historic CLI information corresponding to only the respective serving cell to which the respective CLI report corresponds, and wherein respective estimated CLI information is based on at least one of: respective historic CLI information corresponding to only the respective serving cell to which the respective CLI report corresponds, or respective historic or respective non-historic CLI information corresponding to one or more serving cells different from the respective serving cell to which the respective CLI report corresponds.

In a second aspect, alone or in combination with the first aspect, the network node is configured to receive one or more resources, and wherein, to generate the CLI information, the network node is configured to generate the CLI information based on the one or more resources.

In a third aspect, alone or in combination with one or more of the above aspects, the one or more resources include one or more CLI measurement resources, and wherein the CLI information includes: receive signal strength indicator (RSSI) information; reference signal receive power (RSRP) information; or signal-to-noise ratio information.

In a fourth aspect, alone or in combination with one or more of the above aspects, the respective CLI information included in each respective CLI report of the one or more CLI reports includes a respective CLI value indicative of CLI corresponding to the respective serving cell to which the respective CLI report corresponds.

In a fifth aspect, alone or in combination with one or more of the above aspects, the CLI report information includes multiple CLI reports for a particular serving cell of the one or more serving cells.

In a sixth aspect, alone or in combination with one or more of the above aspects, the CLI report information includes multiple CLI reports per band for a particular serving cell of the one or more serving cells.

In a seventh aspect, alone or in combination with one or more of the above aspects, the multiple CLI reports per band comprise subband CLI reports.

In an eighth aspect, alone or in combination with one or more of the above aspects, to generate the CLI information, the network node generates the respective CLI information of the CLI information corresponding to the respective serving cell to which each respective CLI report corresponds based on: non-historic CLI information corresponding to only the respective serving cell to which the respective CLI report corresponds; historic CLI information corresponding to only the respective serving cell to which the respective CLI report corresponds; or historic or non-historic CLI information corresponding to one or more serving cells different from the respective serving cell to which the respective CLI report corresponds.

In a ninth aspect, alone or in combination with one or more of the above aspects, respective historic CLI information corresponds to a window of past measurements or a threshold quantity of past measurements.

In a tenth aspect, alone or in combination with one or more of the above aspects, the window of past measurements corresponds to a CLI measurement timer.

In an eleventh aspect, alone or in combination with one or more of the above aspects, respective estimated CLI information corresponds to a confidence level greater than or equal to a threshold confidence level.

In a twelfth aspect, alone or in combination with one or more of the above aspects, the network node: receives remediation information configured to reduce CLI at the first network node; and transmits or receive a second transmission based on the remediation information.

In a thirteenth aspect, alone or in combination with one or more of the above aspects, the network node: receives configuration information including information indicative of a remediation action for a second node, wherein the configuration information is configured to reduce CLI at the first network node; and operates based on the configuration information.

In a fourteenth aspect, alone or in combination with one or more of the above aspects, each respective report type indication is one bit in length.

In a fifteenth aspect, alone or in combination with one or more of the above aspects, the CLI report information includes a bitmap, wherein each respective bit of the bitmap indicates whether the CLI report information includes a respective report corresponding to a respective serving cell of the one or more serving cells.

In a sixteenth aspect, alone or in combination with one or more of the above aspects, the CLI report information includes a single respective CLI report for each respective serving cell of the one or more serving cells, and wherein the one or more CLI reports includes each single respective CLI report for each respective serving cell of the one or more serving cells.

In a seventeenth aspect, alone or in combination with one or more of the above aspects, each respective CLI report of the one or more CLI reports includes information indicative of a CLI report identifier (ID).

In an eighteenth aspect, alone or in combination with one or more of the above aspects, each respective CLI report of the one or more CLI reports includes a respective first group of bits and a respective second group of bits, wherein each respective first group of bits includes the respective report ID and the respective report type indication corresponding to the respective CLI report to which the respective first group of bits corresponds, and wherein each respective second group of bits includes the respective CLI information corresponding to the respective CLI report to which the respective second group of bits corresponds.

In a nineteenth aspect, alone or in combination with one or more of the above aspects, each respective first group of bits is a respective first octet and each respective second group of bits is a respective second octet.

In a twentieth aspect, alone or in combination with one or more of the above aspects, each respective CLI report of the one or more CLI reports includes a respective third group of bits, wherein each respective third group of bits includes a respective extension indication and at least one of: information indicative of the respective serving cell to which the respective CLI report corresponds or information indicative of a respective bandwidth part (BWP) identifier (ID) to which the respective CLI report corresponds.

In a twenty-first aspect, alone or in combination with one or more of the above aspects, each respective extension indication indicates whether the CLI report information includes or excludes a subsequent CLI report relative to the respective CLI report to which the respective extension indication corresponds.

In a twenty-second aspect, alone or in combination with one or more of the above aspects, each respective first group of bits is a respective first octet, each respective second group of bits is a respective second octet, and each respective third group of bits is a respective third octet.

In a twenty-third aspect, alone or in combination with one or more of the above aspects, the CLI report information includes bandwidth part (BWP) information for each serving cell of the one or more serving cells.

In a twenty-fourth aspect, alone or in combination with one or more of the above aspects, the CLI report information includes a single respective CLI report for each respective serving cell of the one or more serving cells, wherein the one or more CLI reports includes each single respective CLI report for each respective serving cell of the one or more serving cells, and wherein the CLI report information excludes information indicative of any CLI report identifier (ID) for the one or more CLI reports.

In a twenty-fifth aspect, alone or in combination with one or more of the above aspects, the CLI report information excludes information indicative of any CLI report ID for the one or more CLI reports based on a CLI report configuration indication in downlink control information (DCI) or in a medium access control control element (MAC CE).

In a twenty-sixth aspect, alone or in combination with one or more of the above aspects, the CLI report information includes one or more CLI reports for each respective serving cell of the one or more serving cells.

In a twenty-seventh aspect, alone or in combination with one or more of the above aspects, each respective CLI report of the one or more CLI reports includes a respective termination indication indicative of whether the respective CLI report to which the respective termination indication corresponds is a last CLI report for the respective serving cell to which the respective CLI report corresponds.

In a twenty-eighth aspect, each respective CLI report of the one or more CLI reports includes information indicative of a CLI report identifier (ID).

In a twenty-ninth aspect, alone or in combination with one or more of the above aspects, the CLI report information includes at least one of: information indicative of the respective serving cell to which each respective CLI report corresponds or information indicative of a respective bandwidth part (BWP) identifier (ID) to which each respective CLI report corresponds.

In a thirtieth aspect, alone or in combination with one or more of the above aspects, to the CLI report information includes information indicative of a single CLI report identifier (ID) which indicates a CLI report configuration for each of the one or more serving cells.

In a thirty-first aspect, alone or in combination with one or more of the above aspects, to generate the CLI information, the network node is configured to: generate first CLI for one or more first subbands of a slot based on CLI measurement information for the one or more first subbands; and generate second CLI for one or more second subbands of the slot by extrapolating based on the first CLI, wherein at least one subband of the one or more first subbands is adjacent to at least one subband of the one or more second subbands.

In a thirty-second aspect, alone or in combination with one or more of the above aspects, to generate the CLI information, the network node is configured to: generate first CLI for one or more first subbands of a slot based on CLI measurement information for the one or more first subbands, wherein the one or more first subbands are contiguous subbands; and generate second CLI for one or more second subbands of the slot by extrapolating based on the first CLI, wherein the one or more second subbands are contiguous subbands and separate from the one or more first subbands.

In a thirty-third aspect, alone or in combination with one or more of the above aspects, the respective CLI information included in each respective CLI report of the one or more CLI reports includes a respective CLI value indicative of CLI corresponding to the respective serving cell to which the respective CLI report corresponds, and wherein the network node is configured to: determine whether a particular respective CLI value satisfies a condition, wherein the condition corresponds to a CLI level threshold for each serving cell or a serving cell group; and determine to include the particular respective CLI value in the CLI report information based on the particular CLI value satisfying the condition; or determine to not include the particular respective CLI value in the CLI report information based on the particular CLI value not satisfying the condition.

In a thirty-fourth aspect, alone or in combination with one or more of the above aspects, each respective CLI report of the one or more CLI reports includes a respective includes a respective single bit indicator, and wherein a particular value of the respective single bit indicator indicates that that corresponding respective CLI report information does not include a corresponding respective CLI value.

In a thirty-fifth aspect, alone or in combination with one or more of the above aspects, each respective CLI report of the one or more CLI reports includes a respective multiple bit field, and wherein a particular value of the respective multiple bit field indicates that that corresponding respective CLI report information does not include a corresponding respective CLI value.

In a thirty-sixth aspect, alone or in combination with one or more of the above aspects, the network node is configured to: generate self-interference (SI) information corresponding to self-interference, wherein the self-interference corresponds interference caused by a transmitter of the first network node and received at a receiver of the first network node; and transmit SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information.

In a thirty-seventh aspect, alone or in combination with one or more of the above aspects, the SI report information is transmitted with the CLI report information.

In a thirty-eighth aspect, alone or in combination with one or more of the above aspects, each SI report of the one or more SI reports corresponds to a time period.

In a thirty-ninth aspect, alone or in combination with one or more of the above aspects, each SI report of the one or more SI reports corresponds to a respective serving cell of one or more serving cells.

In another aspect, an apparatus includes at least one processor and a memory coupled to the at least one processor. The at least one processor is configured to generate self-interference (SI) information corresponding to self-interference, wherein the self-interference corresponds interference caused by the transmitter and received at the receiver; and transmit SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information.

In some such aspects, the network node is configured to generate cross-link interference (CLI) information corresponding to cross-link interference, wherein the cross-link interference corresponds to one or more serving cells; and transmit CLI report information including one or more CLI reports, wherein each CLI report of the one or more CLI reports corresponds to a respective serving cell of the one or more serving cells, wherein each CLI report of the one or more CLI reports includes respective CLI information of the CLI information corresponding to the respective serving cell to which the respective CLI report corresponds, wherein each CLI report of the one or more CLI reports includes a respective report type indication, and wherein each respective report type indication is indicative of whether the respective CLI information included in the respective CLI report to which it corresponds includes respective actual CLI information or respective estimated CLI information.

In some such aspects, the CLI report information is transmitted with the SI report information. Additionally, any of the first through the thirty-ninth aspects may be combined with the above other aspect.

Accordingly, wireless communication devices may perform improved CLI reporting operations for wireless communication devices. By performing enhanced CLI and/or SI reporting, throughput can be increased and latency can be reduced.

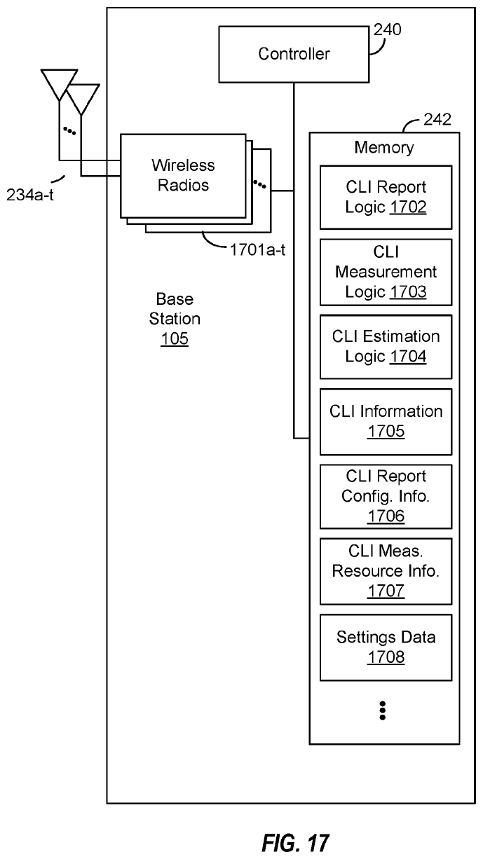

FIG. 15 is a flow diagram illustrating example blocks executed wireless communication device (e.g., a UE or network entity, such as a base station) configured according to an aspect of the present disclosure. The example blocks will also be described with respect to base station 105 as illustrated in FIG. 17. FIG. 17 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1701a-t and antennas 234a-t. Wireless radios 1701a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 17, memory 242 stores resource allocation logic 1702, resource element mapping logic 1703, broadcast logic 1704, resource allocation information data 1705, timing information data 1706, slot configuration data 1707, and settings data 1708. The data (1702-1708) stored in the memory 242 may include or correspond to the data (406, 408, 442, and/or 444) stored in the memory 432 of FIG. 4.

At block 1500, a wireless communication device, such as a network device (e.g., a base station 105), receives, from a second network node, cross-link interference (CLI) report information including one or more CLI reports. Each CLI report of the one or more CLI reports corresponds to a respective serving cell of one or more serving cells, and each CLI report of the one or more CLI reports includes respective CLI information of CLI information corresponding to the respective serving cell to which the respective CLI report corresponds. Each CLI report of the one or more CLI reports includes a respective report type indication, and each respective report type indication is indicative of whether the respective CLI information included in the respective CLI report to which it corresponds includes respective actual CLI information or respective estimated CLI information. For example, the base station 105 may receive the CLI report transmission 454 from the UE 115 and/or the second UE 403, which includes CLI report information 408.

At block 1501, the wireless communication device determines, based on the CLI report information, a remediation action configured to reduce CLI for the second network node. For example, the remediation manager 440 of the base station 105 may determine one or more remediation actions for the base station 105, and optionally, one or more UEs, such as the UE 115 and/or the second UE 403.

At block 1502, the wireless communication device operates based on the remediation action. For example, the base station 105 may transmit remediation information in the remediation indication 456 to one or more UEs (e.g., UE 115 and/or second UE 403). To illustrate, a transmitter (e.g., transmit processor 220/TX MIMO processor 230 or transmitter 434) of the base station 105 transmits the remediation indication 456 via wireless radios 1701a-t and antennas 234a-t using the transmission bandwidth for the transmission.

The wireless communication device (e.g., such as a UE or base station) may execute additional blocks (or the wireless communication device may be configured further perform additional operations) in other implementations. For example, the wireless communication device may perform one or more operations as described with reference to FIGS. 4, 5, 6, 11A, and 11B. As another example, the wireless communication device may perform one or more aspects as described above with reference to FIG. 14.

In a first aspect, to operate based on the remediation action, the network node is configured to: transmit remediation information to the second network node or to a third network node, the remediation information configured reduce CLI at the second network node.

In a second aspect, alone or in combination with the first aspect, to operate based on the remediation action, the network node is configured to: transmit configuration information, wherein the configuration information includes a remediation action configured reduce CLI at the second network node.

In a third aspect, alone or in combination with one or more of the above aspects, to operate based on the remediation action, the network node is configured to: transmit second CLI information to a base station, the second CLI information based on the CLI report information, the second CLI information configured to enable the base station to generate remediation information to reduce CLI for the second network node.

In a fourth aspect, alone or in combination with one or more of the above aspects, to operate based on the remediation action, the network node is configured to: generate remediation information for a third network node based on the CLI report information; and transmit the remediation information to a base station, the remediation information indicating a remediation action for the third network node configured to reduce CLI at the second network node.

In a fifth aspect, alone or in combination with one or more of the above aspects, to operate based on the remediation action, network node is configured to: receive, from the second network node, SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information; determine, based on the SI report information, a second remediation action configured to reduce SI for the second network node; and operate based on the second remediation action.

In another aspect, an apparatus includes at least one processor and a memory coupled to the at least one processor. The at least one processor is configured to receive, from a second network node, SI report information including one or more SI reports, wherein each SI report of the one or more SI reports includes respective SI information of the SI information, wherein each SI report of the one or more SI reports includes a respective report type indication, and wherein each respective report type indication is indicative of whether the respective SI information included in the respective SI report to which it corresponds includes respective actual SI information or respective estimated SI information; determine, based on the SI report information, a remediation action configured to reduce SI for the second network node; and operate based on the remediation action.

In some such aspects, the network node is configured to: receive, from the second network node, cross-link interference (CLI) report information including one or more CLI reports, wherein each CLI report of the one or more CLI reports corresponds to a respective serving cell of one or more serving cells, wherein each CLI report of the one or more CLI reports includes respective CLI information of CLI information corresponding to the respective serving cell to which the respective CLI report corresponds, wherein each CLI report of the one or more CLI reports includes a respective report type indication, and wherein each respective report type indication is indicative of whether the respective CLI information included in the respective CLI report to which it corresponds includes respective actual CLI information or respective estimated CLI information;

In some such aspects, the at least one processor is configured to determine, based on the CLI report information, a remediation action configured to reduce CLI for the second network node; and operate based on the remediation action.

In some such aspects, the CLI report information is transmitted with the SI report information. Additionally, any of the first through the thirty-ninth aspects may be combined with the above other aspect.

Accordingly, wireless communication devices may perform improved CLI reporting operations for wireless communication devices. By performing enhanced CLI and/or SI reporting, throughput can be increased and latency can be reduced.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-17 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A first network node for wireless communication, comprising:
at least one processor; and
a memory coupled to the at least one processor,
wherein the at least one processor is configured to:
generate cross-link interference (CLI) information corresponding to cross-link interference, wherein the cross-link interference corresponds to one or more serving cells; and
transmit CLI report information including one or more CLI reports, wherein each CLI report of the one or more CLI reports corresponds to a respective serving cell of the one or more serving cells, wherein each CLI report of the one or more CLI reports includes respective CLI information of the CLI information corresponding to the respective serving cell to which the respective CLI report corresponds, wherein each CLI report of the one or more CLI reports includes a respective report type indication, and wherein each respective report type indication is indicative of whether the respective CLI information included in the respective CLI report to which it corresponds includes respective actual CLI information or respective estimated CLI information.

2. The first network node of claim 1, wherein, wherein respective actual CLI information is based on respective non-historic CLI information corresponding to only the respective serving cell to which the respective CLI report corresponds, and wherein respective estimated CLI information is based on at least one of:
respective historic CLI information corresponding to only the respective serving cell to which the respective CLI report corresponds, or
respective historic or respective non-historic CLI information corresponding to one or more serving cells different from the respective serving cell to which the respective CLI report corresponds.

3. The first network node of claim 1, wherein the at least one processor is configured to receive one or more resources, and wherein, to generate the CLI information, the at least one processor is configured to generate the CLI information based on the one or more resources.

4. The first network node of claim 3, wherein the one or more resources include one or more CLI measurement resources, and wherein the CLI information includes:
receive signal strength indicator (RSSI) information;
reference signal receive power (RSRP) information; or
signal-to-noise and interference (SINR) ratio information.

5. The first network node of claim 1, wherein the respective CLI information included in each respective CLI report of the one or more CLI reports includes a respective CLI value indicative of CLI corresponding to the respective serving cell to which the respective CLI report corresponds.

6. The first network node of claim 1, wherein the CLI report information includes multiple CLI reports for a particular serving cell of the one or more serving cells.

7. The first network node of claim 1, wherein the CLI report information includes multiple CLI reports per band for a particular serving cell of the one or more serving cells.

8. The first network node of claim 7, wherein the multiple CLI reports per band comprise subband CLI reports.

9. The first network node of claim 1, wherein, to generate the CLI information, the at least one processor is configured to generate the respective CLI information of the CLI information corresponding to the respective serving cell to which each respective CLI report corresponds based on:
non-historic CLI information corresponding to only the respective serving cell to which the respective CLI report corresponds;
historic CLI information corresponding to only the respective serving cell to which the respective CLI report corresponds; or
historic or non-historic CLI information corresponding to one or more serving cells different from the respective serving cell to which the respective CLI report corresponds.

10. The first network node of claim 1, wherein respective historic CLI information corresponds to a window of past measurements or a threshold quantity of past measurements.

11. The first network node of claim 10, wherein the window of past measurements corresponds to a CLI measurement timer.

12. The first network node of claim 1, wherein respective estimated CLI information corresponds to a confidence level greater than or equal to a threshold confidence level.

13. The first network node of claim 1, wherein the at least one processor is configured to:
receive remediation information configured to reduce CLI at the first network node; and
transmit or receive a second transmission based on the remediation information.

14. The first network node of claim 1, wherein the at least one processor is configured to:
receive configuration information including information indicative of a remediation action for a second node, wherein the configuration information is configured to reduce CLI at the first network node; and
operate based on the configuration information.

15. The first network node of claim 1, wherein each respective report type indication is one bit in length.

16. The first network node of claim 1, wherein the CLI report information includes a bitmap, wherein each respective bit of the bitmap indicates whether the CLI report information includes a respective report corresponding to a respective serving cell of the one or more serving cells.

17. The first network node of claim 1, wherein the CLI report information includes a single respective CLI report for each respective serving cell of the one or more serving cells, and wherein the one or more CLI reports includes each single respective CLI report for each respective serving cell of the one or more serving cells.

18. The first network node of claim 17, wherein each respective CLI report of the one or more CLI reports includes information indicative of a CLI report identifier (ID).

19. The first network node of claim 18, wherein each respective CLI report of the one or more CLI reports includes a respective first group of bits and a respective second group of bits, wherein each respective first group of bits includes the respective report ID and the respective report type indication corresponding to the respective CLI report to which the respective first group of bits corresponds, and wherein each respective second group of bits includes the respective CLI information corresponding to the respective CLI report to which the respective second group of bits corresponds.

20. The first network node of claim 19, wherein each respective first group of bits is a respective first octet and each respective second group of bits is a respective second octet.

21-46. (canceled)
